(19) United States
(12) Patent Application Publication
(10) Pub. No.: US 2020/0062899 A1
(43) Pub. Date: Feb. 27, 2020

(54) METHOD FOR PREPARING POLYCARBONATE ETHER POLYOLS

(71) Applicant: Econic Technologies Ltd., Macclesfield, Cheshire (GB)

(72) Inventors: Michael Kember, Macclesfield, Cheshire (GB); Carly Anderson, Macclesfield, Cheshire (GB)

(21) Appl. No.: 16/488,885

(22) PCT Filed: Mar. 1, 2018
(86) PCT No.: PCT/EP2018/055091

§ 371 Date: Aug. 26, 2019

(30) Foreign Application Priority Data
Mar. 1, 2017 (GB) 1703331.7

(51) Int. Cl. C08G 64/34; C08G 64/02; C08G 65/26; B01J 27/26

(52) U.S. Cl. CPC C08G 64/34; C08G 64/0208; B01J 27/26; C08G 65/2603; C08G 65/2663

(57) ABSTRACT

The present invention relates to a method for preparing a polycarbonate ether polyol, by reacting an epoxide and carbon dioxide in the presence of a catalyst of formula (I), a double metal cyanide (DMC) catalyst and a starter compound. The catalyst of formula (I) is as follows:

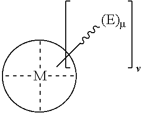

### TECHNICAL FIELD

The present invention relates to a method for preparing a polycarbonate ether polyol, by reacting an epoxide and carbon dioxide in the presence of a catalyst of formula (I), a double metal cyanide (DMC) catalyst and a starter compound.

### BACKGROUND

Polyurethanes are polymers which are prepared by reacting a di- or polyisocyanate with a polyol. Polyurethanes are used in many different products and applications, including as insulation panels, high performance adhesives, high-resilience foam seating, seals and gaskets, wheels and tyres, synthetic fibres, and the like.

The polyols used to make polyurethanes are polymers which have multiple reactive sites (e.g. multiple hydroxyl functional groups). The polyols which are most commonly used are based on polyethers or polyesters.

Polyethers are polymers having —C—O—C— linkages in their backbones. Polyethylene oxide (PEO) and polypropylene oxide (PPO) are examples of polyethers.

The nature and properties of the polyols have a great impact on the nature and the properties of the resultant polyurethanes. It is desirable to include polycarbonate linkages in the backbone of polyether polyols, as carbonate linkages in the polyol may improve the properties of the resultant polyurethane, for example, the presence of carbonate linkages may improve the UV stability, hydrolytic stability, chemical resistance and/or mechanical strength of the resulting polyurethane. The presence of carbonate linkages also increases the viscosity of the resulting polyol, which can limit use in some applications. It is therefore important to be able to control the ratio of ether linkages to carbonate linkages in polyols to tailor properties for widespread application. It is also important to be able to control the molecular weight and polydispersity of the polyol, as these properties impact usefulness and ease of processing of the resultant polyols.

Thus, it would be advantageous to provide a system to tune the amount of ether and carbonate linkages in order to tailor the properties of resulting polymer accordingly and to produce a range of different products for different markets.

One method for making polyether polyols in industry is by reacting an epoxide with a double metal cyanide (DMC) catalyst in the presence of a starter compound.

“DMC” catalyst is a term commonly used in documents and published patents to refer to catalysts having at least two metal centres and a cyanide ligand. Many patents related to methods for preparing the DMC catalyst and methods for preparing polyether using the DMC catalyst are disclosed [e.g. US 2008/0167502 (BASF); US 2003/0158449 (Bayer); US 2003/0069389 (Shell); US 2004/0220430 (Repsol Quimica); U.S. Pat. No. 5,536,883 (Arco); US 2005/0065383 (Dow), and U.S. Pat. No. 3,427,256 (The General Tyre and Rubber Company)].

DMC catalysts for use in the preparation of polyethers were first disclosed in U.S. Pat. No. 3,427,256 by The General Tyre and Rubber Company. It was subsequently found that carrying out this reaction in the presence of a starter compound yielded a polyether polyol.

DMC catalysts are also capable of preparing polyether polyols which contain carbonate linkages in the polymer backbone (hereinafter referred to as polycarbonate ether polyols). It should be noted that the term “polycarbonate ether” can interchangeably be used with the term “polyether carbonate”. To prepare these types of polymers, the reaction is typically carried out at high pressures of carbon dioxide. It has generally been found that, for DMC catalysts, in order to obtain appreciable incorporation of carbon dioxide, the reaction must be carried out at pressures of 40 bar or above. This is undesirable as industrial equipment for preparing polyols are typically limited to pressures of up to 10 bar. For example, in US 2013/0072602, the examples set out the polymerisation of propylene oxide in the presence of a starter compound, and an additive at 50 bar CO₂. The resulting polycarbonate ether polyols incorporate between 17.8 and 24.1 wt % CO₂. Similar results can be seen in US 2013/0190462.

In WO 2015/022290, the examples show that when the polymerisation of propylene oxide is carried out in the presence of a DMC catalyst and a starter compound in the range of 15-25 bar CO₂, the resulting polyols incorporated between 10.0 and 15.4 wt % CO₂.

It is therefore desirable to obtain appreciable incorporation of carbon dioxide (e.g. 20 wt % carbon dioxide, which requires a proportion of carbonate linkages of −0.5 in the polymer backbone, depending on the nature of the starter used).

WO 2012/121508 relates to a process for preparing polycarbonate ethers, which are ultimately intended for use as resins and soft plastics. The process disclosed in WO 2012/121508 requires the copolymerisation of an epoxide and carbon dioxide in the presence of a DMC catalyst and a metal salen catalyst. The examples are each carried out at 16 bar CO₂ or above. The resulting polycarbonate ethers contain varying amounts of ether and carbonate linkages, with 0.67 carbonate (i.e. 67%) being the highest carbonate content achieved in WO 2012/121508, at a pressure of 28 bar. However, said polymers have a high molecular weight, have high polydispersity indices (that is, PDIs of 3.8 and above) and are not terminated by hydroxyl groups. These polymers cannot therefore be used to make polyurethanes.

WO 2010/028362 discloses a method for making polycarbonate polyols by copolymerising carbon dioxide and an epoxide in the presence of a chain transfer agent and a catalyst having a permanent ligand set which complexes a single metal atom. The polyols prepared in the examples have a proportion of carbonate linkages 0.95 in the polymer backbone. These systems are designed to prepare polycarbonates having little or no ether linkages in the polymer backbones.

It is therefore desirable to be able to tailor a polycarbonate ether polyol product having a specific balance of flexibility, strength, stability and viscosity by controlling the relative amounts of ether and carbonate linkages. It is also important to be able to control the molecular weight and polydispersity of the polyol, as these properties impact usefulness and ease of processing of the resultant polyols.

Thus, it would be advantageous to provide a catalyst system to vary the amount of ether and carbonate linkages in order to tailor the properties of the resulting polycarbonate ether polyol accordingly and, ultimately, to produce a range of different polyurethane products for different markets.

The dual catalyst system of the present invention may be used in a polymerisation reaction that is carried out at temperatures which are not considered optimal in the art for either catalyst when used alone. For example, DMC catalysts generally operate effectively at relatively high temperatures, such as about 110-130° C.

In contrast, catalysts comprising salen or porphyrin ligands are known to be unstable at the temperatures typically used with DMC catalysts. In particular, if copolymerisation reactions are carried out at about 50° C. or above, the metal in such ligands can undergo reduction to an inactive species. For example, the active metal centre Co(III) in a cobalt salen catalyst may be reduced to an inactive Co(II) species at high temperature. Consequently, such catalysts are typically used at temperatures below about 50° C. (see Xia et al, Chem. Eur. J., 2015, 21, 4384-4390).

It is therefore surprising that the method of the present invention comprising both a DMC catalyst and a catalyst of formula (I) can be carried out at temperatures that are generally considered in the art to be unsuitable for the individual catalysts when used alone.

### SUMMARY OF THE INVENTION

The invention relates to a method for preparing a polycarbonate ether polyol by reacting an epoxide and carbon dioxide in the presence of double metal cyanide (DMC) catalyst, a catalyst of formula (I), and a starter compound.

The catalyst of formula (I) is as follows:

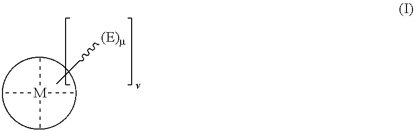

wherein:

M is a metal cation represented by M-(L)ᵥ;

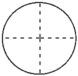

is a multidentate ligand (e.g. it may be either (i) a tetradentate ligand, or (ii) two bidentate ligands);

(E)_{μ} represents one or more activating groups attached to the ligand(s), where [symbol] is a linker group covalently bonded to the ligand, each E is an activating functional group; and μ is an integer from 1 to 4 representing the number of E groups present on an individual linker group;

L is a coordinating ligand, for example, L may be a neutral ligand, or an anionic ligand that is capable of ring-opening an epoxide;

v is an integer from 0 to 4; and

v′ is an integer that satisfies the valency of M, or is such that the complex represented by formula (I) above has an overall neutral charge. For example, v′ may be 0, 1 or 2, e.g. v′ may be 1 or 2.

If v′ is 0 or if v′ is a positive integer and each L is a neutral ligand which is not capable of ring opening an epoxide, v is an integer from 1 to 4.

The DMC catalyst comprises at least two metal centres and cyanide ligands. The DMC catalyst may additionally comprise at least one of: one or more complexing agents, water, a metal salt and/or an acid (e.g. in non-stoichiometric amounts).

For example, the DMC catalyst may comprise:

M′_{d}[M″ₑ(CN)_{f}]_{g}

wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), SOI), W(IV), W(VI), Cu(II), and Cr(III), M″ is selected from Fe(II), Fe(III), Co(II), Co(III), Cr(II), Cr(III), Mn(II), Mn(III), Ir(III), Ni(II), Rh(III), Ru(II), V(IV), and V(V); and

d, e, f and g are integers, and are chosen to such that the DMC catalyst has electroneutrality.

The starter compound may be of the formula (III):

Z—R^{Z})ₐ (III)

Z can be any group which can have 2 or more —R^{Z} groups attached to it. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group.

a is an integer which is at least 2, each R^{Z} may be —OH, —NHR′, —SH, —C(O)OH, —P(O)(OR′)(OH), —PR′(O)(OH)₂ or —PR′(O)OH, and R′ may be H, or optionally substituted alkyl, heteroalkyl, aryl, heteroaryl, cycloalkyl or heterocycloalkyl.

The method can be carried out at pressure of between about 1 bar and about 20 bar, such as between about 1 bar and about 15 bar carbon dioxide.

The method can be carried out at temperatures of from about 0° C. to about 250° C., for example from about 5° C. to about 200° C., e.g. from about 10° C. to about 150° C., such as from about 15° C. to about 100° C., for example, from about 20° C. to about 80° C. It is particularly preferred that the method of the invention is carried out at from about 40° C. to about 80° C.

The invention also provides a polymerisation system for the copolymerisation of carbon dioxide and an epoxide, comprising:
a. a catalyst of formula (I) as defined herein,
b. a DMC catalyst as defined herein, and
c. a starter compound as herein.

The invention is capable of preparing polycarbonate ether polyols which have n ether linkages and m carbonate linkages, wherein n and m are integers, and wherein m/(n+m) is from greater than zero to less than 1.

The polyols prepared by the method of the invention may be used for further reactions, for example to prepare a polyurethane, for example by reacting a polyol composition comprising a polyol prepared by the method of the invention with a composition comprising a di- or polyisocyanate.

### Definitions

For the purpose of the present invention, an aliphatic group is a hydrocarbon moiety that may be straight chain (i.e., unbranched), branched or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl, cycloalkenyl, alkynyl or cycloalkenyl groups, and combinations thereof.

An aliphatic group is preferably a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Preferably, an aliphatic group is a C₁₋₂₀aliphatic, more preferably a C₁₋₁₅aliphatic, more preferably a C₁₋₁₀aliphatic, even more preferably a C₁₋₈aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is preferably a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₅ alkyl, preferably a C₁₋₁₂ alkyl, more preferably a C₁₋₁₀ alkyl, even more preferably a C₁₋₈ alkyl, even more preferably a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are preferably “C₂₋₂₀alkenyl” and “C₂₋₂₀alkynyl”, more preferably “C₂₋₁₅ alkenyl” and “C₂₋₁₅ alkynyl”, even more preferably “C₂₋₁₂ alkenyl” and “C₂₋₁₂ alkynyl”, even more preferably “C₂₋₁₀alkenyl” and “C₂₋₁₀ alkynyl”, even more preferably “C₂₋₈ alkenyl” and “C₂₋₈ alkynyl”, most preferably “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Preferably, an alicyclic group has from 3 to 15, more preferably from 3 to 12, even more preferably from 3 to 10, even more preferably from 3 to 8 carbon atoms, even more preferably from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore preferably contain from 2 to 21 atoms, preferably from 2 to 16 atoms, more preferably from 2 to 13 atoms, more preferably from 2 to 11 atoms, more preferably from 2 to 9 atoms, even more preferably from 2 to 7 atoms, wherein at least one atom is a carbon atom. Particularly preferred heteroatoms are selected from B, O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

A heteroalicyclic group is an alicyclic group as defined above which has, in addition to carbon atoms, one or more ring heteroatoms, which are preferably selected from O, S, N, P and Si. Heteroalicyclic groups preferably contain from one to four heteroatoms, which may be the same or different. Heteroalicyclic groups preferably contain from 5 to 20 atoms, more preferably from 5 to 14 atoms, even more preferably from 5 to 12 atoms.

An aryl group or aryl ring is a monocyclic or polycyclic ring system having from 5 to 20 carbon atoms, wherein at least one ring in the system is aromatic and wherein each ring in the system contains three to twelve ring members. The term “aryl” can be used alone or as part of a larger moiety as in “aralkyl”, “aralkoxy”, or “aryloxyalkyl”. An aryl group is preferably a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydronaphthalene are also included in the aryl group.

The term “heteroaryl” used alone or as part of another term (such as “heteroaralkyl”, or “heteroaralkoxy”) refers to groups having 5 to 14 ring atoms, preferably 5, 6, or 9 ring atoms; having 6, 10, or 14π electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of nitrogen. The term “heteroaryl” also includes groups in which a heteroaryl ring is fused to one or more aryl, cycloaliphatic, or heterocyclyl rings, where the radical or point of attachment is on the heteroaromatic ring. Examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. Thus, a heteroaryl group may be mono- or polycyclic.

The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7-14-membered bicyclic heterocyclic moiety that is saturated, partially unsaturated, or aromatic and having, in addition to carbon atoms, one or more, preferably one to four, heteroatoms, as defined above. When used in reference to a ring atom of a heterocycle, the term “nitrogen” includes a substituted nitrogen.

Examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, imidazolidine, indole, indoline, indolizine, indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

The terms “halo”, “halide” and “halogen” are used interchangeably and, as used herein mean a fluorine atom, a chlorine atom, a bromine atom, an iodine atom and the like, preferably a fluorine atom, a bromine atom or a chlorine atom, and more preferably a fluorine atom.

A haloalkyl group is preferably a “C₁₋₂₀ haloalkyl group”, more preferably a “C₁₋₁₅ haloalkyl group”, more preferably a “C₁₋₁₂ haloalkyl group”, more preferably a “C₁₋₁₀ haloalkyl group”, even more preferably a “C₁₋₈ haloalkyl group”, even more preferably a “C₁₋₆ haloalkyl group” and is a C₁₋₂₀ alkyl, a C₁₋₁₅ alkyl, a C₁₋₁₂ alkyl, a C₁₋₁₀ alkyl, a C₁₋₈ alkyl, or a C₁₋₆ alkyl group, respectively, as described above substituted with at least one halogen atom, preferably 1, 2 or 3 halogen atom(s). In certain embodiments, the term “haloalkyl” encompasses fluorinated or chlorinated groups, including perfluorinated compounds. Specifically, examples of “C₁₋₂₀ haloalkyl group” include fluoromethyl group, difluoromethyl group, trifluoromethyl group, fluoroethyl group, difluroethyl group, trifluoroethyl group, chloromethyl group, bromomethyl group, iodomethyl group and the like.

The term “acyl” as used herein refers to a group having a formula —C(O)R where R is hydrogen or an optionally substituted aliphatic, aryl, or heterocyclic group.

An alkoxy group is preferably a “C₁₋₂₀ alkoxy group”, more preferably a “C₁₋₁₅ alkoxy group”, more preferably a “C₁₋₁₂ alkoxy group”, more preferably a “C₁₋₁₀ alkoxy group”, even more preferably a “C₁₋₈ alkoxy group”, even more preferably a “C₁₋₆ alkoxy group” and is an oxy group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively. Specifically, examples of “C₁₋₂₀ alkoxy group” include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1,1-dimethylpropoxy group, 1,2-dimethylpropoxy group, 2,2-dimethylpropoxy group, 2-methylbutoxy group, 1-ethyl-2-methylpropoxy group, 1,1,2-trimethylpropoxy group, 1,1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group and the like.

An aryloxy group is preferably a “C₅₋₂₀ aryloxy group”, more preferably a “C₆₋₁₂ aryloxy group”, even more preferably a “C₆₋₁₀ aryloxy group” and is an oxy group that is bonded to the previously defined C₅₋₂₀ aryl, C₆₋₁₂ aryl, or C₆₋₁₀ aryl group respectively.

An alkylaryl group is preferably a “C₆₋₁₂ aryl C₁₋₂₀ alkyl group”, more preferably a preferably a “C₆₋₁₂ aryl C₁₋₁₆ alkyl group”, even more preferably a “C₆₋₁₂ aryl C₁₋₆ alkyl group” and is an aryl group as defined above bonded at any position to an alkyl group as defined above. The point of attachment of the alkylaryl group to a molecule may be via the alkyl portion and thus, preferably, the alkylaryl group is —CH₂-Ph or —CH₂CH₂-Ph. An alkylaryl group can also be referred to as “aralkyl”.

A silyl group is preferably a group —Si(Rₛ)₃, wherein each Rₛ can be independently an aliphatic, heteroaliphatic, alicyclic, heteroalicyclic, aryl or heteroaryl group as defined above. In certain embodiments, each Rₛ is independently an unsubstituted aliphatic, alicyclic or aryl. Preferably, each Rₛ is an alkyl group selected from methyl, ethyl or propyl.

An ester group is preferably —OC(O)R₁₂— or —C(O)OR₁₂— wherein R₁₂ can be an aliphatic, heteroaliphatic, alicyclic, heteroalicyclic, aryl or heteroaryl group as defined above. In certain embodiments, R₁₂ is unsubstituted aliphatic, alicyclic or aryl. Preferably R₁₂ is methyl, ethyl, propyl or phenyl. The ester group may be terminated by an aliphatic, heteroaliphatic, alicyclic, heteroalicyclic, aryl or heteroaryl group. It will be appreciated that if R₁₂ is hydrogen, then the group defined by —OC(O)R₁₂— or —C(O)OR₁₂— will be a carboxylic acid group.

A carboxylate group is preferably —OC(O)R₁₄, wherein R₁₄ can be hydrogen, an aliphatic, heteroaliphatic, alicyclic, heteroalicyclic, aryl or heteroaryl group as defined above. In certain embodiments, R₁₄ is unsubstituted aliphatic, alicyclic or aryl. Preferably R₁₄ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

A carbonate group is preferably —OC(O)OR₁₈, wherein R₁₈ can be hydrogen, an aliphatic, heteroaliphatic, alicyclic, heteroalicyclic, aryl or heteroaryl group as defined above. In certain embodiments, R₁₈ is optionally substituted aliphatic, alicyclic or aryl. Preferably R₁₈ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. It will be appreciated that if R₁₈ is hydrogen, then the group defined by —OC(O)OR₁₈ will be a carbonic acid group.

As used herein, the term “protecting group” is used to denote a functional group that can be used to mask the reactivity of another functional group. For example, in chemical synthesis, it is often necessary to mask the reactivity of an acidic hydrogen atom on a hydroxyl group, to allow a reaction to take place at another site on the molecule. The hydroxyl group can therefore be “protected” or its reactivity can be “masked” through a reaction with another compound, which can then be removed later in the chemical synthesis, in a step known as “deprotection”.

A variety of protecting groups are described in Protecting Groups in Organic Synthesis by Wuts and Greene, 4th edition, John Wiley & Sons, Inc. 2006, the entirety of which is incorporated herein by reference.

Suitable protecting groups for oxygen (e.g. hydroxyl groups) for use in the present invention include acetyl groups, benzoyl groups, benzyl groups, β-methoxymethylether (MEM) groups, [bis-(4-methoxyphenyl)phenylmethyl] (DMT) groups, Methoxymethyl ether (MOM) groups, methoxytrityl [(4-methoxyphenyl)diphenylmethyl] (MMT) groups, p-methoxybenzyl ether (PMB) groups, methylthiomethyl ether groups, pivaloyl (Piv) groups, tetrahydropyranyl (THP) groups, tetrahydrofuran (THF) groups, trityl (triphenylmethyl, Tr) groups, silyl ether groups including trimethylsilyl (TMS) groups, tert-butyldimethylsilyl (TBDMS) groups, tri-iso-propylsilyloxymethyl (TOM) groups, and triisopropylsilyl (TIPS) groups, methyl ethers and ethoxyethyl ethers.

Suitable protecting groups for nitrogen (e.g. amine groups) for use in the present invention include carbobenzyloxy (Cbz) groups, p-methoxybenzyl carbonyl (Moz or MeOZ) groups, tert-butyloxycarbonyl (BOC) groups, 9-fluorenylmethyloxycarbonyl (FMOC) groups, acetyl (Ac) groups, benzoyl (Bz) groups, benzyl (Bn) groups, carbamate groups, p-methoxybenzyl (PMB) groups, 3,4-dimethoxybenzyl (DMPM) groups, p-methoxyphenyl (PMP) groups, trichloroethyl chloroformate (Troc) groups, 4-nitro-benzene-1-sulfonyl (Nosyl) groups and 2-nitrophenylsulfonyl (Nps) groups.

Suitable protecting groups for phosphorous, such as might be found on a phosphonate or phosphate group, for use in the present invention include alkyl esters (such as methyl, ethyl and tert-butyl esters), allyl esters (such as vinyl esters), 2-cyanoethyl esters, s-(trifluoromethylsilyl)ethyl esters, 2-(methylsulfonyl)ethyl esters and 2,2,2-trichloroethyl esters.

For the purposes of the present invention, the epoxide substrate is not limited. The term epoxide therefore relates to any compound comprising an epoxide moiety (i.e. a substituted or unsubstituted oxirane compound). Substituted oxiranes include monosubstituted oxiranes, disubstituted oxiranes, trisubstituted oxiranes, and tetrasubstituted oxiranes. In certain embodiments, epoxides comprise a single oxirane moiety. In certain embodiments, epoxides comprise two or more oxirane moieties.

Examples of epoxides which may be used in the present invention include, but are not limited to, cyclohexene oxide, styrene oxide, ethylene oxide, propylene oxide, butylene oxide, substituted cyclohexene oxides (such as limonene oxide, C₁₀H₁₆O or 2-(3,4-epoxycyclohexyl)ethyltrimethoxysilane, C₁₁H₂₂O), alkylene oxides (such as ethylene oxide and substituted ethylene oxides), unsubstituted or substituted oxiranes (such as oxirane, epichlorohydrin, 2-(2-methoxyethoxy)methyl oxirane (MEMO), 2-(2-(2-methoxyethoxy)ethoxy) methyl oxirane (ME2MO), 2-(2-(2-(2-methoxyethoxy)ethoxy)ethoxy)methyl oxirane (ME3MO), 1,2-epoxybutane, glycidyl ethers, vinyl-cyclohexene oxide, 3-phenyl-1,2-epoxypropane, 1,2- and 2,3-epoxybutane, isobutylene oxide, cyclopentene oxide, 2,3-epoxy-1,2,3,4-tetrahydronaphthalene, indene oxide, and functionalized 3,5-dioxaepoxides. Examples of functionalized 3,5-dioxaepoxides include:

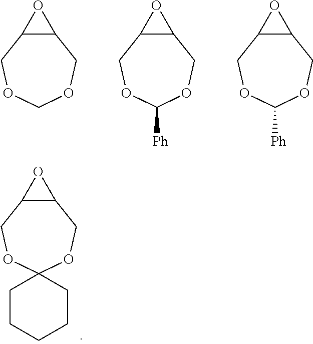

The epoxide moiety may be a glycidyl ether, glycidyl ester or glycidyl carbonate. Examples of glycidyl ethers, glycidyl esters glycidyl carbonates include:

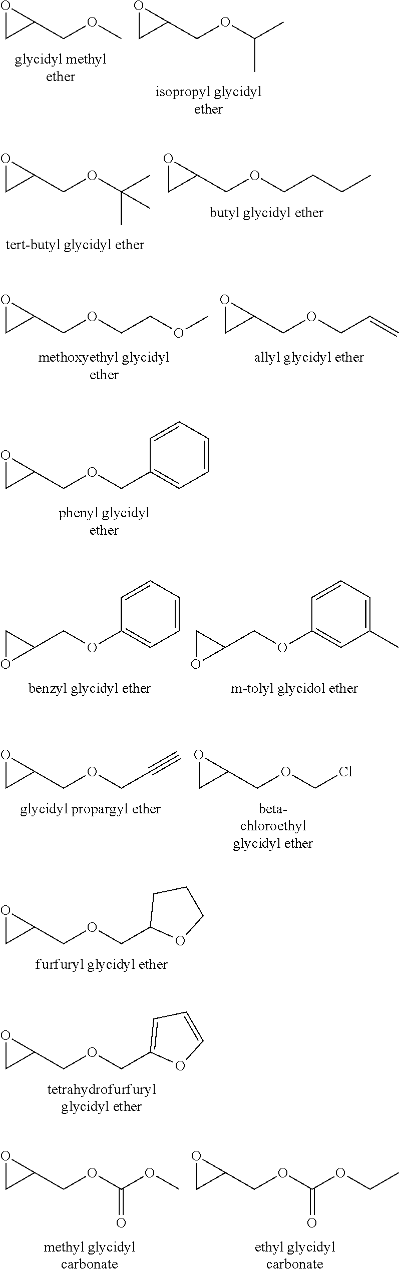

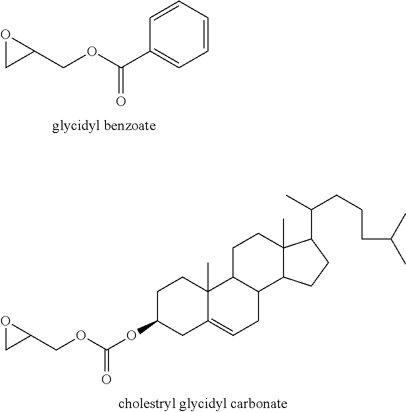 [SMILES: O=C(OCC1CO1)c1ccccc1 ; CC(C)CCCC(C)C1CCC2C3CC=C4C[C@@H](OC(=O)OCC5CO5)CCC4(C)C3CCC12C]

As noted above, the epoxide substrate may contain more than one epoxide moiety, i.e. it may be a bis-epoxide, a tris-epoxide, or a multi-epoxide containing moiety. Examples of compounds including more than one epoxide moiety include bisphenol A diglycidyl ether and 3,4-epoxycyclohexylmethyl 3,4-epoxycyclohexanecarboxylate. It will be understood that reactions carried out in the presence of one or more compounds having more than one epoxide moiety may lead to cross-linking in the resulting polymer.

The skilled person will appreciate that the epoxide can be obtained from “green” or renewable resources. The epoxide may be obtained from a (poly)unsaturated compound, such as those deriving from a fatty acid and/or terpene, obtained using standard oxidation chemistries.

The epoxide moiety may contain —OH moieties, or protected —OH moieties. The —OH moieties may be protected by any suitable protecting group. Suitable protecting groups include methyl or other alkyl groups, benzyl, allyl, tert-butyl, tetrahydropyranyl (THP), methoxymethyl (MOM), acetyl (C(O)alkyl), benzolyl (C(O)Ph), dimethoxytrityl (DMT), methoxyethoxymethyl (MEM), p-methoxybenzyl (PMB), trityl, silyl (such as trimethylsilyl (TMS), t-butyldimethylsilyl (TBDMS), t-butyldiphenylsilyl (TBDPS), tri-iso-propylsilyloxymethyl (TOM), and triisopropylsilyl (TIPS)), (4-methoxyphenyl)diphenylmethyl (MMT), tetrahydrofuranyl (THF), and tetrahydropyranyl (THP).

The epoxide preferably has a purity of at least 98%, more preferably >99%.

It will be understood that the term “an epoxide” is intended to encompass one or more epoxides. In other words, the term “an epoxide” refers to a single epoxide, or a mixture of two or more different epoxides. For example, the epoxide substrate may be a mixture of ethylene oxide and propylene oxide, a mixture of cyclohexene oxide and propylene oxide, a mixture of ethylene oxide and cyclohexene oxide, or a mixture of ethylene oxide, propylene oxide and cyclohexene oxide.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Substituents may be depicted as attached to a bond that crosses a bond in a ring of the depicted molecule. This convention indicates that one or more of the substituents may be attached to the ring at any available position (usually in place of a hydrogen atom of the structure). In cases where an atom of a ring has two substitutable positions, two groups (either the same or different) may be present on that atom.

Preferred optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

Particularly preferred optional substituents for use in the present invention are selected from nitro, C₁₋₁₂ alkoxy (e.g. OMe, OEt, OⁱPr, OⁿBu, O^{t}Bu), C₆₋₁₈ aryl, C₂₋₁₄ heteroaryl, C₂₋₁₄ heteroalicyclic, C₁₋₆ alkyl, C₁₋₆ haloalkyl, F, Cl, Br, I and OH, wherein in each of said C₁₋₁₂ alkoxy, C₆₋₁₈ aryl, C₂₋₁₄ heteroaryl, C₂₋₁₄ heteroalicyclic, C₁₋₆ alkyl and C₁₋₆ haloalkyl group may be optionally substituted by an optional substituent as defined herein.

### DETAILED DESCRIPTION

The present invention provides a method for reacting an epoxide with carbon dioxide in the presence of a catalyst of formula (I), a double metal cyanide (DMC) catalyst, and a starter compound.

### Catalysts of Formula (I)

The catalyst of formula (I) has the following structure:

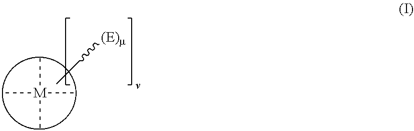

wherein:

M is a metal cation represented by M-(L)ᵥ;

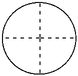

is a multidentate ligand (e.g. it may be either (i) a tetradentate ligand, or (ii) two bidentate ligands);

(E)_{μ} represents one or more activating groups attached to the ligand(s), where [symbol] is a linker group covalently bonded to the ligand, each E is an activating functional group; and μ is an integer from 1 to 4 representing the number of E groups present on an individual linker group;

L is a coordinating ligand, for example, L may be a neutral ligand, or an anionic ligand that is capable of ring-opening an epoxide;

v is an integer from 0 to 4; and

v′ is an integer that satisfies the valency of M, or is such that the complex represented by formula (I) above has an overall neutral charge. For example, v′ may be 0, 1 or 2, e.g. v′ may be 1 or 2. If v′ is 0 or if v′ is a positive integer and each L is a neutral ligand which is not capable of ring opening an epoxide, v is an integer from 1 to 4.

As indicated above, the present invention provides a method for reacting an epoxide with carbon dioxide in the presence of a catalyst of formula (I), a double metal cyanide (DMC) catalyst, and a starter compound. The catalyst of formula (I) therefore contains at least one functional group that is capable of ring opening an epoxide.

The location of the functional group that is capable of ring opening an epoxide is not fixed in the catalyst of formula (I). As such, the coordinating ligand L and/or activating group E (which is tethered to the multidentate ligand) can be capable of ring opening an epoxide. It is important, however, that at least one of E or L is capable of ring opening an epoxide. Thus, when v is 0 (and therefore an E group is absent), at least one anionic L is a ligand that is capable of ring opening an epoxide, and v′ is a positive integer. Alternatively, if v′ is a positive integer and each L is a neutral ligand that is not capable of ring opening and epoxide, then an E group that is capable of ring opening an epoxide is present, and v is a positive integer. In other words, if v′ is 0, or if v′ is a positive integer and each L is a neutral ligand, then v is an integer from 1 to 4.

M can be any metal. However, it is preferred that M is selected from Mg, Ca, Zn, Ti, Cr, Mn, V, Fe, Co, Mo, W, Ru, Al, and Ni. Preferably, M is selected from Mg, Ca, Zn, Ti, Cr, Mn, Fe, Co, Al and Ni. More preferably, M is selected from Cr, Co, Al, Fe and Mn. Even more preferably, M is selected from Cr, Co, Al and Mn. Most preferably, M is selected from Al, Cr, and Co. Thus, the catalyst of formula (I) is most preferably an aluminium, chromium or cobalt complex.

When M is a transition metal, multiple oxidation states of that metal may exist, and these may be used in the catalyst of formula (I). For example, if M is Cr, then M may be either Cr(II) or Cr(III).

Thus, the skilled person will understand that the metal M may be Mg(II), Ca(II), Zn(II), Ti(II), Ti(III), Ti(IV), Cr(II), Cr(III), Mn(II), Mn(III), V(II), V(III), Fe(II), Fe(III), Co(II), Co(III), Mo(IV), Mo(VI), W(IV), W(VI), Ru(II), Ru(III), Al(III), Ni(II) and Ni(III). The skilled person will understand that changing the oxidation state of the metal may require changes to be made to other substituent definitions in order to obtain a charge neutral catalyst of formula (I).

In formula (I)

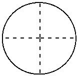

is a multidentate ligand. Preferably,

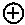

is either (i) two bidentate ligands, or (ii) a tetradentate ligand.

Bidentate ligands are ligands that can co-ordinate with the metal centre in two places, but two bidentate ligands must be present to stabilise the metal centre in the catalyst of formula (I). The two bidentate ligands may be the same or may be different. A bidentate ligand suitable for use in the present invention is shown below:

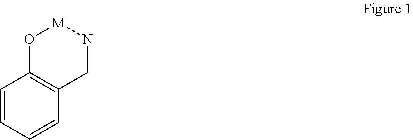

Metal centres may have more than four co-ordination sites, with six co-ordination sites being common when the metal is a transition metal. Therefore, when two bidentate ligands are present, a further ligand may be present. For example, the further ligand (i.e. an anionic ligand L) may be present, e.g. to satisfy the valency of the metal centre or to ensure the neutrality of the overall complex.

For example, if M is a +2 metal cation (e.g. Mg²⁺), and a tetradentate or two bidentate ligands are present, a neutral ligand L may be present. However, in this case, this metal complex will contain at least one functional group that is capable of ring opening an epoxide, for example, at least one E group present (i.e. v may be an integer from 1 to 4). Alternatively, if M is a +2 metal cation (e.g. Mg²⁺), and a tetradentate or two bidentate ligands are present, an anionic ligand L may be present. In this instance, at least one group E may be positively charged, or a counter cation may be present, to ensure the overall neutrality of the complex. For example, the cation may be a tetraalkyl ammonium cation, a bis(triarylphosphine)iminium cation or a tetraalkylphosphonium cation.

If M is a +3 metal cation (e.g. Al³⁺, and a tetradentate or two bidentate ligands are present, an anionic L group may be present, e.g. to satisfy the valency of the metal centre. A further neutral L group may also be present. Alternatively, if M is a +3 metal cation (e.g. Al³⁺), and a tetradentate or two bidentate ligands are present, two anionic L groups may be present. In this instance, at least one group E may be positively charged, or a counter cation may be present, to ensure the overall neutrality of the complex. For example the cation may be a tetraalkyl ammonium cation, a bis(triarylphosphine)iminium cation or a tetraalkyl phosphinium cation.

The arrangement of the bidentate ligands and the other coordinating ligand(s) is not fixed, and many different configurations can be adopted, as shown below:

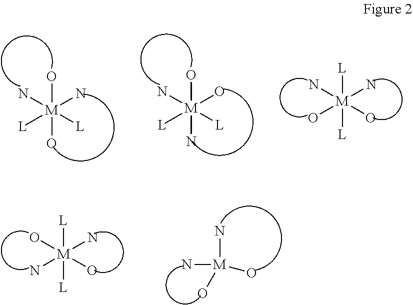

wherein M is a metal centre as defined above, L is a coordinating ligand, and

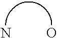

represents a bidentate ligand as shown in FIG. 1 above.

In FIG. 2 above, L may be replaced with an E group that is tethered to the bidentate ligand.

Tetradentate ligands are ligands that can co-ordinate with the metal centre in four places. Examples of tetradentate ligands that are suitable for use in the present invention include the following:

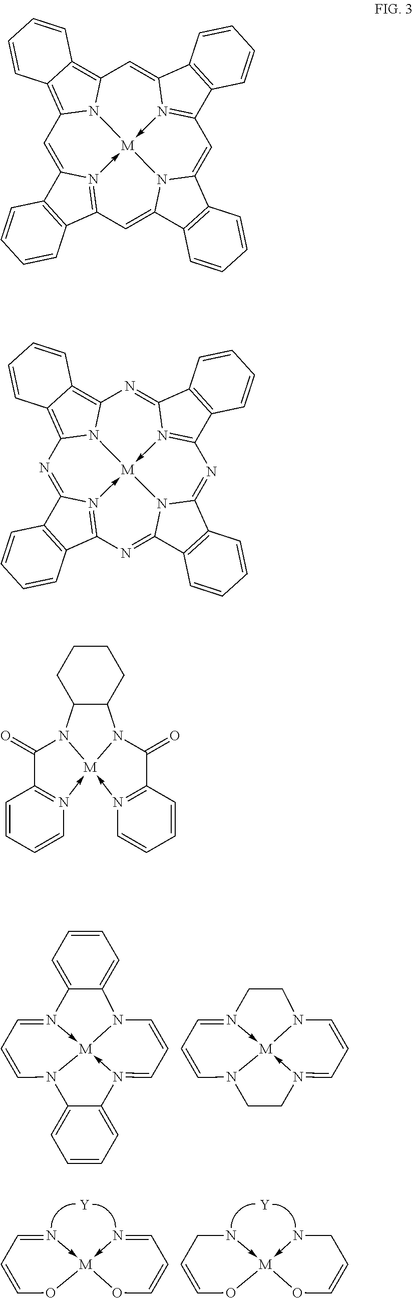

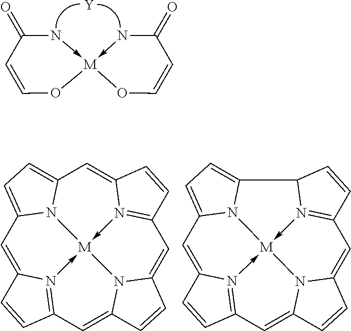

wherein M is the metal centre as defined above in formula (I) and Y is a linking atom or group, such as a carbon, oxygen or nitrogen atom, or an optionally substituted alkyl or alkenyl group.

Salen ligands and derivatives thereof are particularly preferred tetradentate ligands for use in the present invention. These are shown in FIG. 3, see the first two structures on line 3 thereof. A further general salen ligand and preferred salen derivative ligands for use in the catalyst of formula (I) are shown in FIG. 3a below:

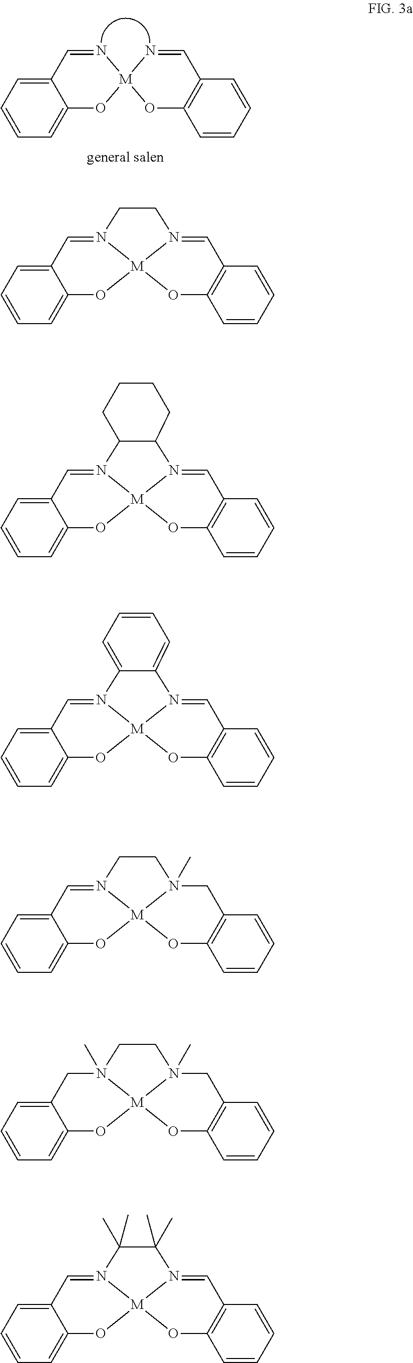

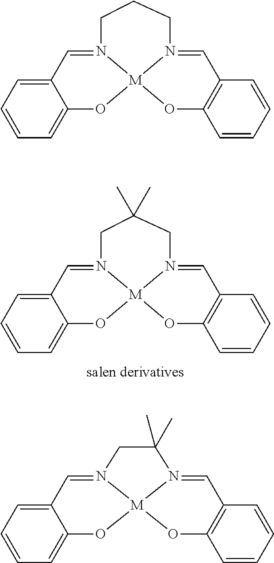

Porphyrin ligands and derivatives thereof are also preferred tetradentate ligands for use in the present invention. These are shown in FIG. 3, see the two structures on line 4 thereof. Particularly preferred porphyrin and porphyrin derivative ligands for use in the catalyst of formula (I) are shown in FIG. 3b below:

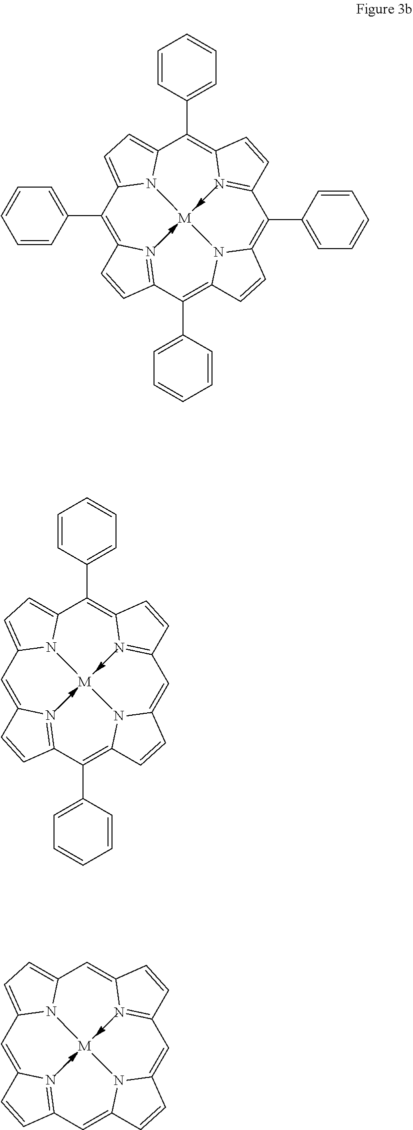

As indicated above, metal centres may have more than four co-ordination sites, with six co-ordination sites being common when the metal centre is a transition metal. Therefore, the structures set out in FIGS. 3, 3a and 3b may also have one or more L ligands coordinated to the metal centre. The ligand L may be a neutral ligand, or the ligand L may be an anoinic ligand which is capable of ring opening an epoxide. When the ligand L is an anion, it may, for example, be present to satisfy the valency of the metal centre or to ensure the overall neutrality of the metal complex.

The complexes set out in FIGS. 3, 3a and 3b may contain a neutral ligand L. It will be appreciated that the structures set out in FIGS. 3, 3a and 3b may contain a mixture of L ligands. In other words, each L may be the same or different. The structures set out in FIGS. 3, 3a and 3b may contain a mixture of a neutral L ligand, and an anionic ligand L which is capable of ring opening an epoxide. For example, one or more further neutral ligands L may also be present.

Therefore, it will be appreciated that if M is a +2 metal cation (e.g. Mg²⁺), a neutral ligand L may be present. In this case, if L is not capable of ring opening an epoxide, the metal complex will contain at least one functional group that is capable of ring opening an epoxide. For example, at least one E group will be present (i.e. v may be an integer from 1 to 4). Alternatively, if M is a +2 metal cation (e.g. Mg²⁺), and a tetradentate or two bidentate ligands are present, an anionic ligand L may be present. In this instance, at least one group E may be positively charged, or a counter cation may be present, to ensure the overall neutrality of the complex. For example, the cation may be a tetraalkyl ammonium cation, a bis(triarylphosphine)iminium cation or a tetraalkyl phosphinium cation.

If M is a +3 metal cation (e.g. Al³⁺), an anionic L group may be present to satisfy the valency of the metal centre. A further neutral L group may also be present. Alternatively, if M is a +3 metal cation (e.g. Al³⁺), and a tetradentate or two bidentate ligands are present, two anionic L groups may be present. In this instance, at least one group E may be positively charged, or a counter cation may be present, to ensure the overall neutrality of the complex. For example, the cation may be a tetraalkyl ammonium cation, a bis(triarylphosphine)iminium cation or a tetraalkyl phosphinium cation.

The skilled person will also appreciate that in FIGS. 2, 3, 3a and 3b, 1 to 4 groups represented by “ [symbol] (E)_{μ}” may also be present (i.e. if v is not 0). However, in Figures FIGS. 2, 3, 3a and 3b, these groups have been omitted for clarity. As will be readily understood by the skilled person, each “ [symbol] (E)_{μ}” group may be attached at any position on the multidentate ligand(s). In other words, any of the hydrogen atoms in the above bidentate and tetradentate ligands in FIGS. 2, 3, 3a and 3b above, may be substituted by a group “ [symbol] (E)_{μ}”.

In FIGS. 2, 3, 3a and 3b above showing bidentate and tetradentate ligands, optional substituents have been omitted for clarity. However, as will be readily understood by the skilled person, any or all of the hydrogen atoms in the above bidentate and tetradentate ligands may be substituted by another atom or functional group, provided that that position is not already substituted by an activating functional group “ [symbol] (E)_{μ}”. Examples of suitable substituent groups include, but are not limited to, —OH, —CN, —NO₂, —N₃, Cl, Br, F, C₁₋₁₂alkyl, C₂₋₁₂ alkenyl, C₂₋₁₂ alkynyl, C₃₋₁₂ cycloalkyl, C₂₋₁₂ heterocycloalkyl, C₆₋₁₈ aryl and C₂₋₁₈ heteroaryl. For the first two porphyrin derivative ligands shown in FIG. 3b above, the pendant phenyl rings on the porphyrin core can be substituted with OMe, OBu, NO₂, Cl, Br, F and I groups. If these substituents are present, then substitution in the para position relative to the site of attachment to the porphyrin core may be preferred.

L is a coordinating ligand. L may be a neutral ligand, or L may be an anionic ligand that is capable of ring-opening an epoxide. It will be appreciated that each coordinating ligand L may be the same or different.

L being an Anionic Ligand Capable of Ring Opening an Epoxide

When L is an anionic ligand which is capable of ring opening an epoxide, it may preferably be independently selected from OC(O)Rₓ, OSO₂Rₓ, OSORₓ, OSO(Rₓ)₂, S(O)Rₓ, ORₓ, phosphinate, halide, nitro, nitrate, hydroxyl, carbonate, amino, amido or optionally substituted aliphatic, heteroaliphatic, alicyclic, heteroalicyclic, aryl or heteroaryl; wherein Rₓ is independently hydrogen, or optionally substituted aliphatic, haloaliphatic, heteroaliphatic, alicyclic, heteroalicyclic, aryl, alkylaryl or heteroaryl.

Preferably L is independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl, (for example silyl), aryl or heteroaryl. Even more preferably, each L is independently OC(O)R^{x}, OR^{x}, halide, carbonate, amino, nitro, nitrate, alkyl, aryl, heteroaryl, phosphinate or OSO₂R^{x}. Preferred optional substituents for when L is aliphatic, heteroaliphatic, alicyclic, heteroalicyclic, aryl or heteroaryl include halogen, hydroxyl, nitrate, cyano, amino, or substituted or unsubstituted aliphatic, heteroaliphatic, alicyclic, heteroalicyclic, aryl or heteroaryl.

R^{x} is independently hydrogen, or optionally substituted aliphatic, haloaliphatic, heteroaliphatic, alicyclic, heteroalicyclic, aryl, alkylaryl, or heteroaryl. Preferably, R^{x} is alkyl, alkenyl, alkynyl, heteroalkyl, aryl, heteroaryl, cycloalkyl, or alkylaryl. Preferred optional substituents for R^{x} include halogen, hydroxyl, cyano, nitro, amino, alkoxy, alkylthio, or substituted or unsubstituted aliphatic, heteroaliphatic, alicyclic, heteroalicyclic, aryl or heteroaryl (e.g. optionally substituted alkyl, aryl, or heteroaryl).

Exemplary options for L include OAc, OC(O)CF₃, lactate, 3-hydroxypropanoate, halogen, NO₃, OSO(CH₃)₂, Et, Me, OMe, OiPr, OtBu, Cl, Br, I, F, N(iPr)₂ or N(SiMe₃)₂, OPh, OBn, salicylate and dioctyl phosphinate.

Preferably L is selected from OC(O)R^{x}, OR^{x}, halide, carbonate, amino, nitro, alkyl, aryl, heteroaryl, phosphinate or OSO₂R^{x}, R^{x} is optionally substituted alkyl, alkenyl, alkynyl, heteroalkyl, aryl, heteroaryl or alkylaryl. More preferably L is OC(O)R^{x}, OR^{x}, halide, alkyl, aryl, heteroaryl, phosphinate or OSO₂R^{x}. Still more preferably L is NO₃, halide, OC(O)R^{x} or OR^{x}. More preferably still, L is selected from OAc, O₂CCF₃, Cl, Br, or OPh. Most preferably, L is Cl, OAc or O₂CCF₃.

Preferably each R^{x} is the same and is selected from an optionally substituted alkyl, alkenyl, alkynyl, heteroalkyl, aryl, heteroaryl, cycloalkyl or alkylaryl. More preferably each R^{x} is the same and is an optionally substituted alkyl, alkenyl, heteroalkyl, aryl, heteroaryl, cycloalkyl or alkylaryl. Still more preferably each R^{x} is the same and is an optionally substituted alkyl, alkenyl, heteroalkyl; or cycloalkyl. More preferably still R^{x} is an optionally substituted alkyl, heteroalkyl or cycloalkyl. Most preferably R^{x} is an optionally substituted alkyl.

It will be appreciated that preferred definitions for L and preferred definitions for R^{x} may be combined. For example, each L may be independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl, (for example silyl), aryl or heteroaryl, e.g. each may be independently OC(O)R^{x}, OR^{x}, halide, carbonate, amino, nitro, alkyl, aryl, heteroaryl, phosphinate or OSO₂R^{x}, and R^{x} may be optionally substituted alkyl, alkenyl, alkynyl, heteroalkyl, aryl, heteroaryl, cycloalkyl, or alkylaryl.

Preferably, L may be OC(O)R^{x} and wherein R^{x} is optionally substituted alkyl, preferably wherein R^{x} is a C₁₋₆ alkyl group optionally substituted with one or more —OH groups. For example, L may be OC(O)CH₂CH₂(OH).

More preferably, L may be OC(O)R^{x} and wherein R^{x} is methyl, ethyl, trifluoromethyl or trifluoroethyl. For example, L may be OC(O)CH₃, OC(O)CH₂CH₃, OC(O)CF₃, OC(O)CH₂CF₃. Most preferably, L is OC(O)CH₃ or OC(O)CF₃.

L being a Neutral Ligand

When L is a neutral ligand, it may be capable of donating a lone pair of electrons (i.e. a Lewis base). In certain embodiments, L may be a nitrogen-containing Lewis base.

Alternatively, when L is a neutral ligand, it may be independently selected from an optionally substituted heteroaliphatic group, an optionally substituted heteroalicyclic group, an optionally substituted heteroaryl group and water. More preferably, L is independently selected from water, an alcohol (e.g. methanol), a substituted or unsubstituted heteroaryl (imidazole, methyl imidazole (for example, N-methyl imidazole), pyridine, 4-dimethylaminopyridine, pyrrole, pyrazole, etc), an ether (dimethyl ether, diethylether, cyclic ethers, etc), a thioether, a carbene, a phosphine, a phosphine oxide, a substituted or unsubstituted heteroalicyclic (morpholine, piperidine, tetrahydrofuran, tetrahydrothiophene, etc), an amine, an alkyl amine trimethylamine, triethylamine, etc), acetonitrile, an ester (ethyl acetate, etc), an acetamide (dimethylacetamide, etc), a sulfoxide (dimethylsulfoxide, etc) etc.

L may be selected from optionally substituted heteroaryl, optionally substituted heteroaliphatic, optionally substituted heteroalicyclic, an ether, a thioether, a carbene, a phosphine, a phosphine oxide, an amine, an alkyl amine, acetonitrile, an ester, an acetamide or a sulfoxide. It will also be appreciated that L may be water; a heteroaryl or heteroalicyclic group which are optionally substituted by alkyl, alkenyl, alkynyl, alkoxy, halogen, hydroxyl, nitro or nitrile. For example, L may be selected from water; a heteroaryl optionally substituted by alkyl (e.g. methyl, ethyl etc), alkenyl or alkynyl.

Exemplary neutral L groups include water, methanol, pyridine, methylimidazole (for example N-methyl imidazole), dimethylaminopyridine (for example, 4-methylaminopyridine), 1,5,7-Triazabicyclo[4.4.0]dec-5-ene (TBD), 7-Methyl-1,5,7-triazabieyclo[4.4.0]dec-5-ene (MTBD) and 1,8-Diazabicyclo[5. 4.0]undec-7-ene (DBU).

It will be appreciated by the skilled person that some neutral L ligands may be capable of ring opening an epoxide. Exemplary neutral L ligands which are capable of ring opening an epoxide include methylimidazole (for example N-methyl imidazole), and dimethylaminopyridine (for example, 4-methylaminopyridine).

The skilled person will appreciate that the catalyst of the invention may have more than one L ligand. If more than one L ligand is present, the complex may contain a mixture of neutral L ligands, and anionic L ligands which are capable of ring opening an epoxide, the identity of L will depend on the nature of the macrocyclic coordinating ligand, and the change of the metal M.

### Linker Groups

Linker groups “ [symbol] ” as shown in formula (I) contain between 1 and 30 carbon atoms, and optionally one or more heteroatoms selected from nitrogen, oxygen, sulfur, silicon, boron and phosphorus. These heteroatoms may be incorporated into the linker “backbone”. For example, the linker may include ether linkages, carbonate linkages, ester linkages or amide linkages. Alternatively, heteroatoms may be present as optional substituents on the linker backbone as, for example, hydroxyl groups, oxo groups, azide groups etc.

The linker may further contain saturated and/or cyclic groups, such as alkene or alkyne groups, carbocyclic rings, including aryl and heteroaryl rings. Thus, the linker can comprise a large number of different function groups, heteroatoms and be of any suitable length. It is, however, important that the linker is long enough to allow the one or more activating groups to be positioned near to the metal atom of the catalyst of formula (I). As such, steric considerations and the relative flexibility of the groups in the linker must be considered. For example, alkyne groups are generally not considered to be flexible, as they have 180° geometry. Therefore, an alkyne group alone would be an unsuitable linker for most ligands. However, an alkyne group may be present in a linker to add rigidity to, for example, an alkyl chain.

Preferred linkers include substituted or unsubstituted, branched or unbranched C₁₋₃₀ alkyl groups, substituted or unsubstituted, branched or unbranched C₂₋₃₀ alkene groups, substituted or unsubstituted, branched or unbranched C₁₋₃₀ ether groups, substituted or unsubstituted aryl groups and substituted or unsubstituted heteroaryl groups.

Preferably, the metal complexes of formula (I) include a metal atom coordinated to either (i) a tetradentate ligand or (ii) two bidentate ligands and at least one activating group E tethered to the ligand

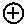

via one or more linker groups [symbol] . Preferably, there are 1 to 4 activating groups E tethered to the ligand

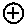

via one to 4 linker groups [symbol] .

Activating groups E for use in the present invention include nitrogen-containing functional groups, phosphorous-containing functional groups, mixed phosphorous and nitrogen-containing functional groups, sulphur-containing functional groups, arsenic-containing functional groups and combinations of thereof.

### Nitrogen-Containing Activating Groups

As indicated above, activating groups E for use in the present invention can include nitrogen-containing compounds. The nitrogen atom in the nitrogen-containing activating group may be neutral or may be positively charged. As will be understood by the skilled person, if the nitrogen atom is charged, then a negatively charged counter ion must be present. This counter ion may be a separate atom or molecule (such as a Cl⁻ ion), making the nitrogen-containing activating group a salt. Alternatively, the charge may be satisfied by a negative charge on another atom within the nitrogen-containing activating group.

An example of a neutral nitrogen-containing activating group is an amine group. An example of a charged nitrogen-containing activating group with a separate counter ion is an amine salt. An example of a charged nitrogen-containing activating group with an internal counter ion is an N-oxide.

Suitable nitrogen-containing activating groups for use in the present invention include

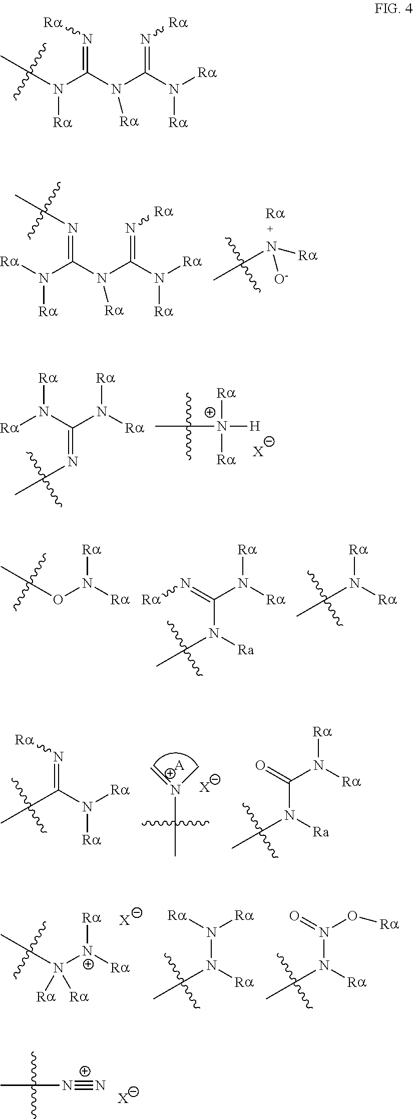

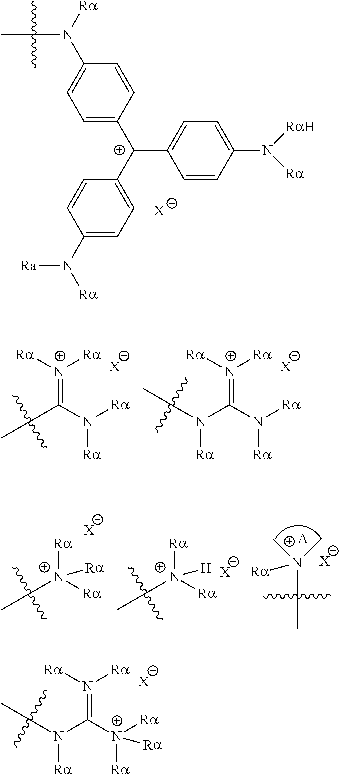

wherein each Rα is independently H; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

wherein two or more Rα groups can be taken together with intervening atoms to form one or more optionally substituted rings optionally containing one or more additional heteroatoms;

X⁻ is an anion, and

ring A is an optionally substituted 5- to 10-membered heteroaryl group.

As indicated above, X⁻ can be any anion. X⁻ may therefore be a nucleophilic or non-nucleophilic anion. Exemplary nucleophilic anions include, but are not limited to, —OR^{a}, —SR^{a}, —O(C═O)R^{a}, —O(C═O)OR^{a}, —O(C═O)N(R^{a})₂, —N(R^{a})(C═O)R^{a}, —NC, —CN, —Br, —I, —Cl, —N₃, —O(SO₂)R^{a} and —OPR^{a}₃, wherein each R^{a} is independently selected from H, optionally substituted aliphatic, optionally substituted heteroaliphatic, optionally substituted aryl and optionally substituted heteroaryl. Exemplary non-nucleophilic anions include, but are not limited to, BF₄⁻ and CF₃SO₃⁻.

The wavy line [symbol] indicates where the nitrogen-containing activating group is attached to the linker.

Other suitable nitrogen-containing activating groups for use in the present invention include:

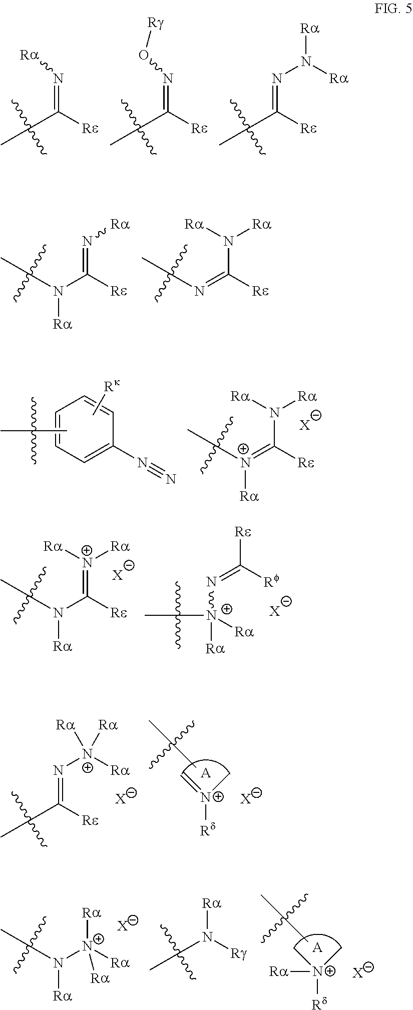

wherein Rα, X⁻ and A are as defined above;

Rδ is hydrogen, hydroxyl, optionally substituted C₁₋₂₀ aliphatic;

each occurrence of Rε and Rϕ is independently H; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7 to 14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

wherein an Rε or Rϕ group can be taken with an Rα group to form one or more optionally substituted rings;

Rγ is H; a protecting group; optionally substituted C₁₋₂₀ acyl; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

each occurrence of R_{κ} is independently selected from the group consisting of: Cl, Br, F, I, —NO₂, —CN, —SR^{b}, —S(O)R^{b}, —S(O)₂R^{b}, —NR^{b}C(O)R^{b}, —OC(O)R^{b}, —CO₂R^{b}, —NCO, —N₃, —OR_{γ}, —OC(O)N(R^{b})₂, —N(R^{b})₂, —NR^{b}C(O)R^{b}, —NR^{b}C(O)OR^{b}; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S;

where each occurrence of R^{b} is independently —H; optionally substituted C₁₋₆ aliphatic; optionally substituted 3- to 7-membered heterocyclic; optionally substituted phenyl; and optionally substituted 8- to 10-membered aryl; and

wherein two or more adjacent R_{κ} groups can be taken together to form an optionally substituted saturated, partially unsaturated, or aromatic 5- to 12-membered ring containing 0 to 4 heteroatoms.

Preferred nitrogen-containing activating groups are shown below:

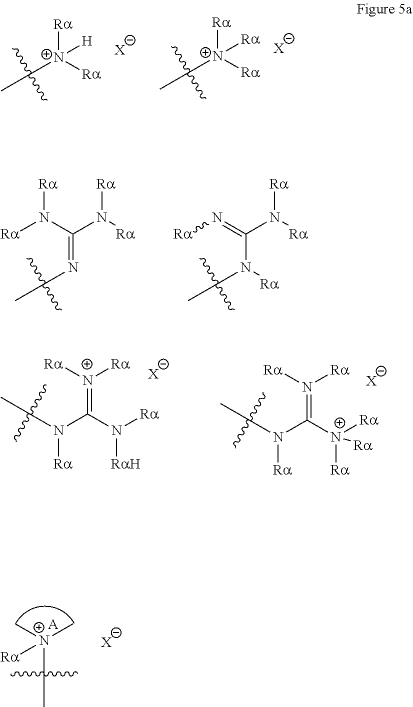

wherein Rα and X⁻ are as defined above.

Particularly preferred nitrogen-containing activating groups are those shown in FIG. 5a, wherein Rα is independently selected from H; optionally substituted C₁₋₆ aliphatic; optionally substituted C₁₋₆ heteroaliphatic and optionally substituted—to 8-membered saturated or partially unsaturated monocyclic carbocycle; and

X⁻ is selected from —OR^{a}, —O(C═O)R^{a}, —O(C═O)OR^{a}, —O(C═O)N(R^{a})₂, —N(R^{a})(C═O)R^{a}, —CN, —F, —Br, —I and —Cl, wherein each R^{a} is independently selected from H, optionally substituted C₁₋₆ aliphatic, optionally substituted C₁₋₆ heteroaliphatic, optionally substituted C₆₋₁₂ aryl and optionally substituted C₃₋₁₁ heteroaryl.

More preferred nitrogen-containing activating groups for use in the present invention are those shown in FIG. 5a, wherein Rα is independently selected from H; optionally substituted C₁₋₆ aliphatic; optionally substituted C₁₋₆ heteroaliphatic and optionally substituted—to 8-membered saturated or partially unsaturated monocyclic carbocycle; and

X⁻ is selected from —F, —Br, —I, —Cl, BF₄, OAc, O₂COCF₃, NO₃, OR^{a} and O(C═O)R^{a}, wherein R^{a} is selected from H, optionally substituted C₁₋₆ alkyl, optionally substituted C₁₋₆ heteroallkyl, optionally substituted C₆₋₁₂ aryl and optionally substituted C₃₋₁₁ heteroaryl.

### Phosphorous-Containing Activating Groups

Activating groups for use in the present invention may contain a phosphorous atom. Phosphorous-containing groups for use in the present invention therefore include phosphonates and phosphites. Examples of suitable phosphorous-containing activating groups are shown in FIG. 6 below:

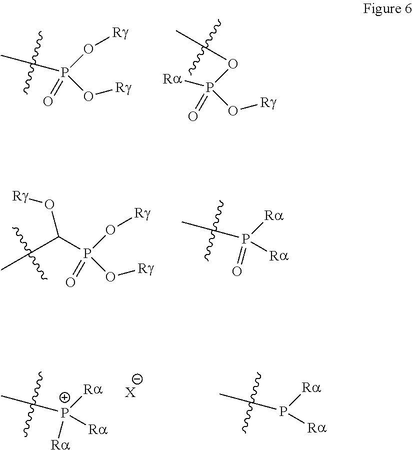

wherein Rα, Rβ and Rγ and are as defined above.

It is noted that two Rγ groups within the same phosphorus-containing activating groups may be taken together with intervening atoms to form an optionally substituted ring structure. Alternatively, an Rγ group may be taken with an Rα or Rβ group to form an optionally substituted ring.

### Mixed Nitrogen- and Phosphorous-Containing Activating Groups

Examples of mixed activating groups containing both N and P atoms are shown below:

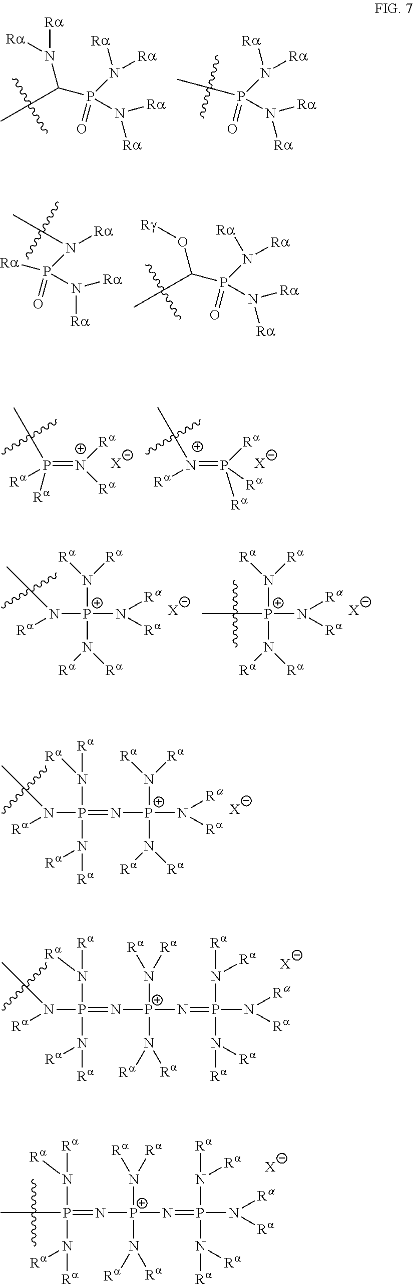

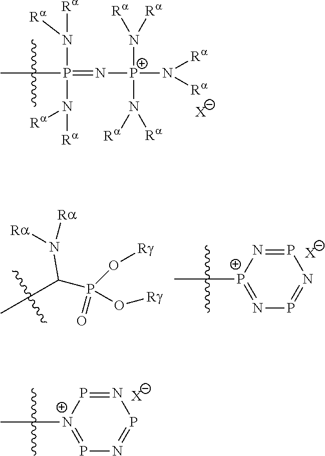

wherein Rα, Rγ and X⁻ are as defined above.

### Activating Groups Containing Other Heteroatoms

As indicated above, activating groups for use in the present invention may also include sulfur or arsenic atoms. Examples of such activating groups are provided below:

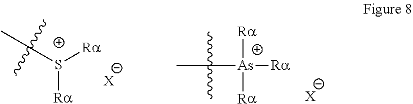

wherein each instance of Rα is the same or different and is as defined above, and

wherein X⁻ is as defined above.

It will be appreciated that when v is 0 (i.e E is absent), the catalyst of the invention may be used in combination with a co-catalyst. Examples of suitable co-catalysts include tetraalkyl ammonium salts (e.g. a tetrabutyl ammonium salt), tetraalkyl phosphinium salts (e.g. a tetrabutyl phosphonium salt), bis(triarylphosphine)iminium salts (e.g. a bis(triphenylphosphine)iminium salt), or a nitrogen containing nucleophile (e.g. methylimidazole (such as N-methyl imidazole), dimethylaminopyridine (for example, 4-methylaminopyridine), 1,5,7-Triazabicyclo[4.4.0]dec-5-ene (TBD), 7-Methyl-1,5,7-triazabicyclo[4.4.0]dec-5-ene (MTBD) or 1,8-Diazabicyclo[5.4.0]undec-7-ene (DBU))..

The counter anion in the salts above may be selected from the same list of options as set forth for X⁻. In other words, the anion in the co-catalyst salt may be selected from —OR^{a}, —SR^{a}, —O(C═O)R^{a}, —O(C═O)OR^{a}, —O(C═O)N(R^{a})₂, —N(R^{a})(C═O)R^{a}, —NC, —CN, —Br, —I, —Cl, —N₃, —O(SO₂)R^{a} and —OPR^{a}₃, wherein each R^{a} is independently selected from H, optionally substituted aliphatic, optionally substituted heteroaliphatic, optionally substituted aryl and optionally substituted heteroaryl. Exemplary anions include —Br, —I, —Cl, and —O(C═O)R^{a}.

The catalysts of formula (I) described above are used together with a double metal cyanide (DMC) catalyst and a starter compound in the synthesis of polycarbonate ether polyols from epoxides and carbon dioxide. Preferred catalysts of formula (I) for use in the method of the present invention are listed below. As will be understood by the skilled person, these embodiments may be combined in any manner to give particularly preferred catalysts of formula (I).

### Embodiment 1

A catalyst of formula (I), in which M is selected from Mg, Ca, Zn, Ti, Cr, Mn, V, Fe, Co, Mo, W, Ru, Al, and Ni.

### Embodiment 2

The catalyst of Embodiment 1, in which M is selected from Cr, Co, Al, Fe and Mn.

### Embodiment 3

The catalyst of Embodiment 2, in which M is selected from Cr, Co, Al and Mn.

### Embodiment 4

The catalyst of Embodiment 3, in which M is selected from Al, Cr and Co.

### Embodiment 5

The catalyst of Embodiment 4, in which M is Cr.

### Embodiment 6

The catalyst of Embodiment 4, in which M is Al.

### Embodiment 7

The catalyst of Embodiment 4, in which M is Co.

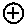

### Embodiment 8

The catalyst of any one of Embodiments 1-7 in which is two bidentate ligands.

### Embodiment 9

The catalyst of Embodiment 8, in which said bidentate ligand is as shown in FIG. 1, or a substituted analogue thereof.

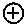

### Embodiment 10

The catalyst of any one of Embodiments 1-7 in which is a tetradentate ligand.

### Embodiment 11

The catalyst of Embodiment 10 in which said tetradentate ligand is selected from those shown in FIG. 3, or a substituted analogue thereof.

### Embodiment 12

The catalyst of Embodiment 11, in which said tetradentate ligand is a salen ligand or salen derivative ligand.

### Embodiment 13

The catalyst of Embodiment 12, wherein said salen ligand or salen derivative is selected from those shown in FIG. 3a.

### Embodiment 14

The catalyst of Embodiment 11, in which said tetradentate ligand is a porphyrin ligand.

### Embodiment 15

The catalyst of Embodiment 14, wherein said porphyrin ligand is as shown in FIG. 3b.

### Embodiment 16

The catalyst of any preceding Embodiment, wherein v is 0.

### Embodiment 17

The catalyst of any one of Embodiments 1 to 15, wherein v is 1.

### Embodiment 18

The catalyst of any one of Embodiments 1 to 15, wherein v is 2.

### Embodiment 19

The catalyst of any one of Embodiments 1 to 15, wherein v is 3.

### Embodiment 20

The catalyst of any one of Embodiments 1 to 15, wherein v is 4.

### Embodiment 21

The catalyst of any one of Embodiments 1 to 15 and 17 to 20, wherein μ is 1.

### Embodiment 22

The catalyst of any one of Embodiments 1 to 15 and 17 to 20, wherein μ is 2.

### Embodiment 23

The catalyst of any one of Embodiments 1 to 15 and 17 to 20, wherein μ is 3.

### Embodiment 24

The catalyst of any one of Embodiments 1 to 15 and 17 to 20, wherein μ is 4.

### Embodiment 25

The catalyst of any one of Embodiments 1 to 15 and 17 to 24, wherein v′ is 0.

### Embodiment 26

The catalyst of any one of Embodiments 1 to 24, wherein v′ is 1.

### Embodiment 27

The catalyst of any one of Embodiments 1 to 24, wherein v′ is 2.

### Embodiment 28

The catalyst of any one of Embodiments 1 to 24, wherein v′ is 3.

### Embodiment 29

The catalyst of any one of Embodiments 1 to 24, wherein v′ is 4.

### Embodiment 30

The catalyst of any one of Embodiments 1 to 15 and 17 to 29 in which the linker group [symbol] is selected from the following:

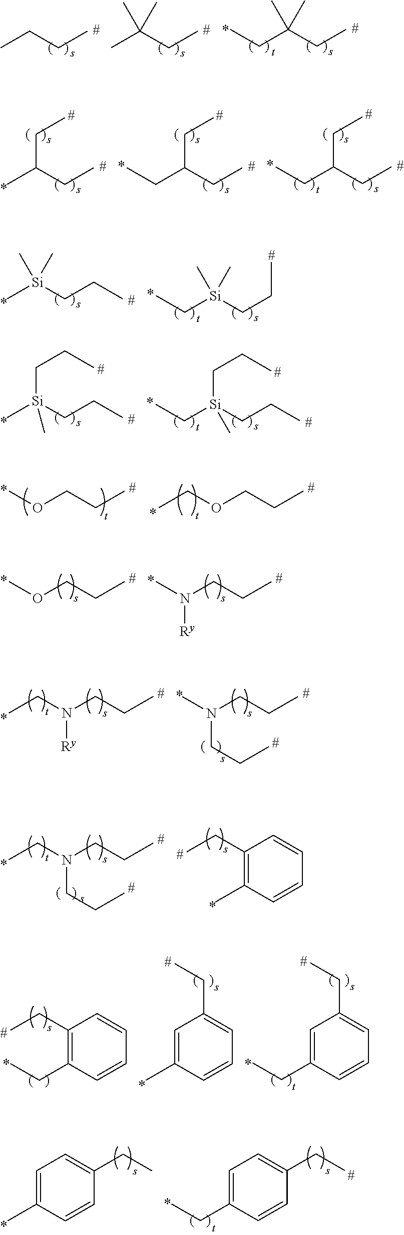

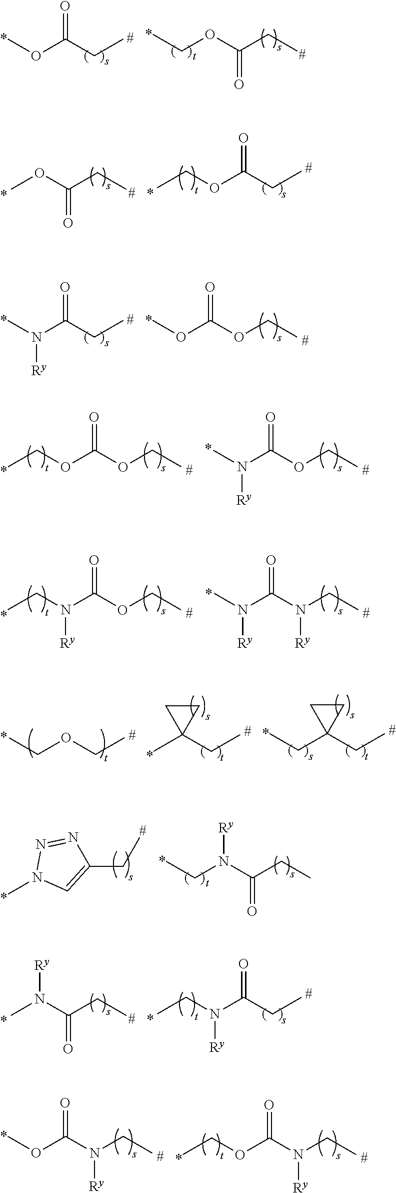

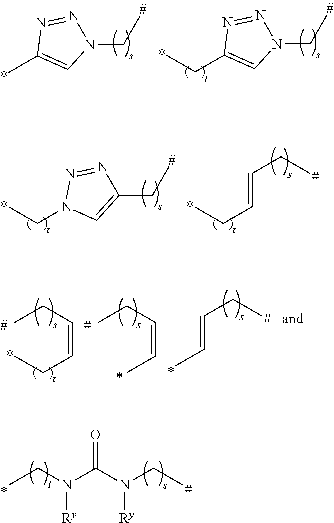

where s=0-6 and t=1-4
where * represents the site of attachment to a ligand, and each # represents a site of attachment of an activating group.

### Embodiment 31

The catalyst of Embodiment 30, wherein the linker group [symbol] is substituted or unsubstituted, branched or unbranched C₁₋₆ alkyl.

### Embodiment 32

The catalyst of any one of Embodiments 1 to 24 and 26 to 31, wherein L is an anionic ligand that is capable of ring opening an epoxide and is independently selected from OC(O)R^{x}, OR^{x}, halide, carbonate, amino, nitro, nitrate, alkyl, aryl, heteroaryl, phosphinate or OSO₂R^{x}, and wherein R^{x} is optionally substituted alkyl, alkenyl, alkynyl, heteroalkyl, aryl, heteroaryl or alkylaryl.

### Embodiment 33

The catalyst of Embodiment 32, wherein L is lactate, 3-hydroxypropanoate, Cl, Br, I, NO₃, optionally substituted phenoxide, OC(O)CF₃ or OC(O)CH₃ groups.

### Embodiment 34

The catalyst of Embodiment 33, wherein L is Cl.

### Embodiment 35

The catalyst of Embodiment 33, wherein L is NO₃.

### Embodiment 36

The catalyst of Embodiment 33, wherein L is optionally substituted phenoxide.

### Embodiment 37

The catalyst of Embodiment 33, wherein L is OC(O)CF₃.

### Embodiment 38

The catalyst of Embodiment 33, wherein L is OC(O)CH₃.

### Embodiment 39

The catalyst of Embodiment 32, wherein L is OC(O)R^{x} and wherein R^{x} is optionally substituted alkyl, preferably wherein R^{x} is a C₁₋₆ alkyl group substituted with one or more —OH groups, more preferably wherein L is 3-hydroxypropanoate or lactate.

### Embodiment 40

The catalyst of any one of Embodiments 1 to 24 and 26 to 31, wherein L is a neutral ligand and is independently selected from water, methanol, pyridine, methylimidazole (for example N-methyl imidazole) and dimethylaminopyridine (for example, 4-methylaminopyridine).

### Embodiment 41

The catalyst of any one of Embodiments 1 to 24 and 26 to 31 comprising at least one anionic L ligand that is capable of ring opening an epoxide and at least one neutral L ligand, preferably wherein the at least one anionic L ligand that is capable of ring opening an epoxide is as defined in any one of Embodiments 32-39, and the at least one neutral L ligand is as defined in Embodiment 40. Embodiment 42: The catalyst of any one of Embodiments 1 to 15 and 17 to 41, wherein the activating group E is a nitrogen-containing activating group.

### Embodiment 43

The catalyst of Embodiment 42, wherein the activating group E is selected from those shown in FIG. 4, FIG. 5 or FIG. 5a.

### Embodiment 44

The catalyst of Embodiment 43, wherein the activating group E is selected from those shown in FIG. 5a.

### Embodiment 45

The catalyst of any one of Embodiments 43 to 45, wherein wherein each Rα is independently H; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

wherein two or more Rα groups can be taken together with intervening atoms to form one or more optionally substituted rings optionally containing one or more additional heteroatoms;

X⁻ is an anion;

ring A is an optionally substituted 5- to 10-membered heteroaryl group;

Rδ is hydrogen, hydroxyl, optionally substituted C₁₋₂₀ aliphatic;

each occurrence of Rε and Rϕ is independently H; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7 to 14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

wherein an Rε or Rϕ group can be taken with an Rα group to form one or more optionally substituted rings;

Rγ is H; a protecting group; optionally substituted C₁₋₂₀ acyl; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S; and

each occurrence of Rκ is independently selected from the group consisting of: Cl, Br, F, I, —NO₂, —CN, —SR^{b}, —S(O)R^{b}, —S(O)₂R^{b}, —NR^{b}C(O)R^{b}, —OC(O)R^{b}, —CO₂R^{b}, —NCO, —N₃, —ORγ, —OC(O)N(R^{b})₂, —N(R^{b})₂, —NR^{b}C(O)R^{b}, —NR^{b}C(O)OR^{b}; optionally substituted C₁₋₂₀ aliphatic; optionally substituted C₁₋₂₀ heteroaliphatic; optionally substituted phenyl; optionally substituted 3- to 8-membered saturated or partially unsaturated monocyclic carbocycle; optionally substituted 7-14 carbon saturated, partially unsaturated or aromatic polycyclic carbocycle; optionally substituted 5- to 6-membered monocyclic heteroaryl ring having 1-4 heteroatoms independently selected from O, N or S; optionally substituted 3- to 8-membered saturated or partially unsaturated heterocyclic ring having 1-3 heteroatoms independently selected from O, N or S; optionally substituted 6- to 12-membered polycyclic saturated or partially unsaturated heterocycle having 1-5 heteroatoms independently selected from O, N or S; or optionally substituted 8- to 10-membered bicyclic heteroaryl ring having 1-5 heteroatoms independently selected from O, N or S;

where each occurrence of R^{b} is independently —H; optionally substituted C₁₋₆ aliphatic; optionally substituted 3- to 7-membered heterocyclic; optionally substituted phenyl; and optionally substituted 8- to 10-membered aryl; and

wherein two or more adjacent Rκ groups can be taken together to form an optionally substituted saturated, partially unsaturated, or aromatic 5- to 12-membered ring containing 0 to 4 heteroatoms.

### Embodiment 46

The catalyst of Embodiment 42 or 45, wherein the activating group E is

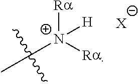

### Embodiment 47

The catalyst of Embodiment 42 or 45, wherein the activating group E is

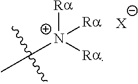

### Embodiment 48

The catalyst of Embodiment 42 or 45, wherein the activating group E is

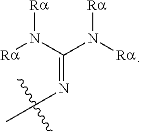

### Embodiment 49

The catalyst of Embodiment 42 or 45, wherein the activating group E is

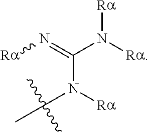

### Embodiment 50

The catalyst of Embodiment 42 or 45, wherein the activating group E is

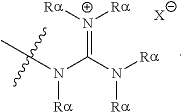

### Embodiment 51

The catalyst of Embodiment 42 or 45, wherein the activating group E is

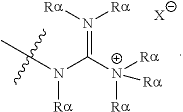

### Embodiment 52

The catalyst of any one of Embodiments 46 to 51, wherein each Roc is independently selected from H; optionally substituted C₁₋₆ aliphatic; optionally substituted C₁₋₆ heteroaliphatic and optionally substituted—to 8-membered saturated or partially unsaturated monocyclic carbocycle; and

X⁻ is selected from —OR^{a}, —O(C═O)R^{a}, —O(C═O)OR^{a}, —O(C═O)N(R^{a})₂, —N(R^{a})(C═O)R^{a}, BF₄, —CN, —F, —Br, —I and —Cl, wherein each R^{a} is independently selected from H, optionally substituted C₁₋₆ aliphatic, optionally substituted C₁₋₆ heteroaliphatic, optionally substituted C₆₋₁₂ aryl and optionally substituted C₃₋₁₁ heteroaryl.

### Embodiment 53

The catalyst of any one of Embodiments 46 to 51, wherein each Rα is independently selected from H; optionally substituted C₁₋₆ aliphatic; optionally substituted C₁₋₆ heteroaliphatic and optionally substituted—to 8-membered saturated or partially unsaturated monocyclic carbocycle; and

X⁻ is selected from —F, —Br, —I, —Cl, BF₄, OAc, O₂COCF₃, NO₃, OR^{a} and O(C═O)R^{a}, wherein R^{a} is selected from H, optionally substituted C₁₋₆ alkyl, optionally substituted C₁₋₆ heteroallkyl, optionally substituted C₆₋₁₂ aryl and optionally substituted C₃₋₁₁ heteroaryl. Embodiment 54: The catalyst of any one of Embodiments 1 to 15 and 17 to 41, wherein the activating group E is a phosphorous-containing activating group.

### Embodiment 55

The catalyst of Embodiment 54, wherein the phosphorous-containing activating group E is selected from those shown in FIG. 6.

### Embodiment 56

The catalyst of Embodiment 55, wherein the phosphorous-containing activating group E is

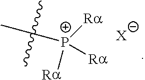

wherein Rα and X⁻ are as defined in Embodiment 52 above.

### Embodiment 57

The catalyst of Embodiment 56, wherein Rα and X⁻ are as defined in Embodiment 53.

### Embodiment 58

The catalyst of any one of Embodiments 1 to 15 and 17 to 41, wherein the activating group E is a mixed nitrogen and phosphorous-containing activating group.

### Embodiment 59

The catalyst of Embodiment 58, wherein the mixed nitrogen and phosphorous-containing activating group E is selected from those shown in FIG. 7.

Particularly preferred catalysts of formula (I) correspond to Embodiments 4, 13, 18, 22, 31 and 44 above.

Most preferred catalysts of formula (I) are as shown below:

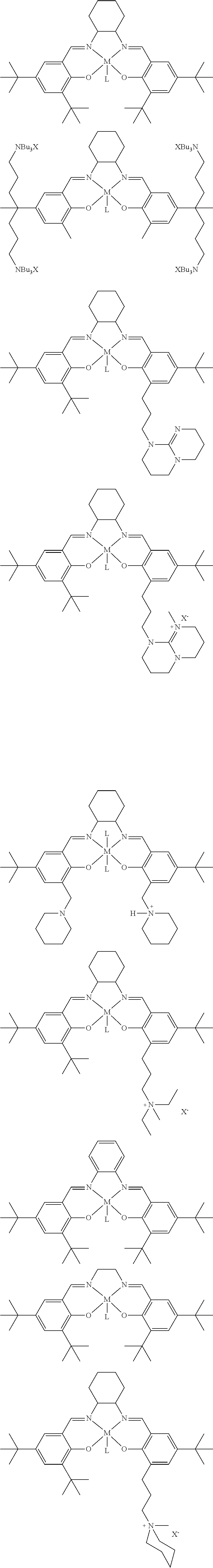

wherein X is an anion, preferably wherein X⁻ is selected from F, Br, I, Cl, BF₄, OAc, O₂COCF₃, NO₃, OR^{a} and O(C═O)R^{a}, wherein R^{a} is selected from H, optionally substituted C₁₋₆ alkyl, optionally substituted C₁₋₆ heteroallkyl, optionally substituted C₆₋₁₂ aryl and optionally substituted C₃₋₁₁ heteroaryl;

L is a coordinating ligand that is capable of ring-opening an epoxide (preferably L is an anionic ligand which is capable of ring opening an epoxide), preferably wherein L is selected from OC(O)R^{x} (e.g. OAc, OC(O)CF₃, lactate, 3-hydroxypropanoate), halogen, NO₃, OSO₂R^{x}, (e.g. OSO(CH₃)₂), R^{x} (e.g. Et, Me), OR^{x} (e.g. OMe, OiPr, OtBu, OPh, OBn), Cl, Br, I, F, N(iPr)₂ or N(SiMe₃)₂, salicylate and alkyl or aryl phosphinate (e.g. dioctyl phosphinate); R^{x} is optionally substituted alkyl, alkenyl, alkynyl, heteroalkyl, aryl, or heteroaryl; and

M is Al, Co or Cr.

### Double Metal Cyanide (DMC) Catalyst

DMC catalysts are complicated compounds which comprise at least two metal centres and cyanide ligands. The DMC catalyst may additionally comprise at least one of: one or more complexing agents, water, a metal salt and/or an acid (e.g. in non-stoichiometric amounts).

The first two of the at least two metal centres may be represented by M′ and M″.

M′ may be selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), SOI), W(IV), W(VI), Cu(II), and Cr(III), M′ is preferably selected from Zn(II), Fe(II), Co(II) and Ni(II), even more preferably M′ is Zn(II).

M″ is selected from Fe(II), Fe(III), Co(II), Co(III), Cr(II), Cr(III), Mn(II), Mn(III), Ir(III), Ni(II), Rh(III), Ru(II), V(IV), and V(V), preferably M″ is selected from Co(II), Co(III), Fe(II), Fe(III), Cr(III), Ir(III), and Ni(II), more preferably M″ is selected from Co(II) and Co(III).

It will be appreciated that the above preferred definitions for M′ and M″ may be combined. For example, preferably M′ may be selected from Zn(II), Fe(II), Co(II) and Ni(II), and M″ may preferably selected form be Co(II), Co(III), Fe(II), Fe(III), Cr(III), Ir(III), and Ni(II). For example, M′ may preferably be Zn(II) and M″ may preferably be selected from Co(II) and Co(III).

If a further metal centre(s) is present, the further metal centre may be further selected from the definition of M′ or M″.

Examples of DMC catalysts which can be used in the method of the invention include those described in U.S. Pat. Nos. 3,427,256, 5,536,883, 6,291,388, 6,486,361, 6,608,231, 7,008,900, 5,482,908, 5,780,584, 5,783,513, 5,158,922, 5,693,584, 7,811,958, 6,835,687, 6,699,961, 6,716,788, 6,977,236, 7,968,754, 7,034,103, 4,826,953, 4,500,704, 7,977,501, 9,315,622, EP-A-1568414, EP-A-1529566, and WO 2015/022290, the entire contents of which are incorporated by reference.

DMC catalysts which are useful in the invention may be produced by treating a solution (such as an aqueous solution) of a metal salt with a solution (such as an aqueous solution) of a metal cyanide salt in the presence of one or more complexing agents, water, and/or an acid. Suitable metal salts include compounds of the formula M′(X′)ₚ, wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), SOI), W(IV), W(VI), Cu(II), and Cr(III), and M′ is preferably selected from Zn(II), Fe(II), Co(II) and Ni(II), even more preferably M′ is Zn(II). X′ is an anion selected from halide, oxide, hydroxide, sulphate, carbonate, cyanide, oxalate, thiocyanate, isocyanate, isothiocyanate, carboxylate and nitrate, preferably X′ is halide. p is an integer of 1 or more, and the charge on the anion multiplied by p satisfies the valency of M′. Examples of suitable metal salts include zinc chloride, zinc bromide, zinc acetate, zinc acetonylacetonate, zinc benzoate, zinc nitrate, iron(II) sulphate, iron (II) bromide, cobalt(II) chloride, cobalt(II) thiocyanate, nickel(II) formate, nickel(II) nitrate, and mixtures thereof.

Suitable metal cyanide salts include compounds of the formula (Y)q[M″(CN)_{b}(A)_{c}], wherein M″ is selected from Fe(II), Fe(III), Co(II), Co(III), Cr(II), Cr(III), Mn(II), Mn(III), Ir(III), Ni(II), Rh(III), Ru(II), V(IV), and V(V), preferably M″ is selected from Co(II), Co(III), Fe(II), Fe(III), Cr(III), Ir(III), and Ni(II), more preferably M″ is selected from Co(II) and Co(III). Y is a proton (H⁺) or an alkali metal ion or an alkaline earth metal ion (such as K⁺), A is an anion selected from halide, oxide, hydroxide, sulphate, cyanide oxalate, thiocyanate, isocyanate, isothiocyanate, carboxylate and nitrate. q and b are integers of 1 or more, preferably b is 4 or 6. c may be 0 or an integer of 1 or more. The sum of the charges on the ions Y, CN and A multiplied by q, b and c respectively (e.g. Y×q+CN×b+A×c) satisfies the valency of M″. Examples of suitable metal cyanide salts include potassium hexacyanocobaltate(III), potassium hexacyanoferrate(II), potassium hexacyanoferrate(III), calcium hexacyanocobaltate(III), lithium hexacyanocolbaltate(III), and mixtures thereof.

Suitable complexing agents include (poly)ethers, polyether carbonates, polycarbonates, poly(tetramethylene ether diol)s, ketones, esters, amides, alcohols, ureas and the like. Exemplary complexing agents include propylene glycol, polypropylene glycol (PPG), (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol etc. It will be appreciated that the alcohol may be saturated or may contain an unsaturated moiety (e.g. a double or triple bond). Multiple (i.e. more than one different type of) complexing agents may be present in the DMC catalysts used in the present invention.

The DMC catalyst may comprise a complexing agent which is a polyether, polyether carbonate or polycarbonate.

Suitable polyethers for use in the present invention include those produced by ring-opening polymerisation of cyclic ethers, and include epoxide polymers, oxetane polymers, tetrahydrofuran polymers, and the like. Any method of catalysis can be used to make the polyethers. The polyethers can have any desired end groups, including, for example, hydroxyl, amine, ester, ether, or the like. Preferred polyethers for use in the present invention are polyether polyols having between 2 and 8 hydroxyl groups. It is also preferred that polyethers for use in the present invention have a molecular weight between about 1,000 Daltons and about 10,000 Daltons, more preferably between about 1,000 Daltons and about 5,000 Daltons. Polyether polyols useful in the DMC catalyst of the present invention include PPG polyols, EO-capped PPG polyols, mixed EO-PO polyols, butylene oxide polymers, butylene oxide copolymers with ethylene oxide and/or propylene oxide, polytetramethylene ether glycols, and the like. Preferred polyethers include PPGs, such as PPG polyols, particularly diols and triols, said PPGs having molecular weights of from about 250 Daltons to about 8,000 Daltons, more preferably from about 400 Daltons to about 4,000 Daltons.

Suitable polyether carbonates for use in the DMC catalyst of the present invention may be obtained by the catalytic reaction of alkylene oxides and carbon dioxide in the presence of a suitable starter or initiator compound. The polyether carbonates used as the complexing agent can also be produced by other methods known to the person skilled in the art, for example by partial alcoholysis of polycarbonate polyols with di- or tri-functional hydroxy compounds. The polyether carbonates used as the complexing agent preferably have an average hydroxyl functionality of 1 to 6, more preferably 2 to 3, most preferably 2.

Suitable polycarbonates for use in the DMC catalyst of the present invention may be obtained by the polycondensation of difunctional hydroxy compounds (generally bis-hydroxy compounds such as alkanediols or bisphenols) with carbonic acid derivatives such as, for example, phosgene or bis[chlorocarbonyloxy] compounds, carbonic acid diesters (such as diphenyl carbonate or dimethyl carbonate) or urea. Methods for producing polycarbonates are generally well known and are described in detail in for example “Houben-Weyl, Methoden der organischen Chemie”, Volume E20, Makromolekulare Stoffe, 4^{th} Edition, 1987, p. 1443-1457, “Ullmann's Encyclopedia of Industrial Chemistry”, Volume A21, 5^{th} Edition, 1992, p. 207-215 and “Encyclopedia of Polymer Science and Engineering”, Volume 11, 2^{nd} Edition, 1988, p. 648-718. Aliphatic polycarbonate diols having a molecular weight of from about 500 Daltons to 5000 Daltons, most highly preferably from 1000 Daltons to 3000 Daltons, are particularly preferably used. These are generally obtained from non-vicinal diols by reaction with diaryl carbonate, dialkyl carbonate, dioxolanones, phosgene, bischloroformic acid esters or urea (see for example EP-A 292 772 and the documents cited therein). Suitable non-vicinal diols are in particular 1,4-butanediol, neopentyl glycol, 1,5-pentanediol, 2-methyl-1,5-pentanediol, 3-methyl-1,5-pentanediol, 1,6-hexanediol, bis-(6-hydroxyhexyl)ether, 1,7-heptanediol, 1,8-octanediol, 2-methyl-1,8-octanediol, 1,9-nonanediol, 1,10-decanediol, 1,4-bis-hydroxymethyl cyclohexane, diethylene glycol, triethylene glycol, tetraethylene glycol, dipropylene glycol, tripropylene glycol, tetrapropylene glycol, alkoxylation products of diols with ethylene oxide and/or propylene oxide and/or tetrahydrofuran with molar masses up to 1000 Daltons, preferably between 200 Daltons and 700 Daltons, and in rarer cases the dimer diols, which are obtainable by reducing both carboxyl groups of dimer acids, which in turn can be obtained by dimerisation of unsaturated vegetable fatty acids. The non-vicinal diols can be used individually or in mixtures. The reaction can be catalysed by bases or transition metal compounds in the manner known to the person skilled in the art.

Other complexing agents that may be useful in present invention include poly(tetramethylene ether diols). Poly(tetramethylene ether diols) are polyether polyols based on tetramethylene ether glycol, also known as polytetrahydrofuran (PTHF) or polyoxybutylene glycol. These poly(tetramethylene ether diols) comprise two OH groups per molecule. They can be produced by cationic polymerisation of tetrahydrofuran (THF) with the aid of catalysts.

Complexing agents, as defined above, may be used to increase or decrease the crystallinity of the resulting DMC catalyst.

Suitable acids for use in the DMC catalyst of the present invention may have the formula HᵣX′″, where X′″ is an anion selected from halide, sulfate, phosphate, borate, chlorate, carbonate, cyanide, oxalate, thiocyanate, isocyanate, isothiocyanate, carboxylate and nitrate, preferably X′″ is a halide. r is an integer corresponding to the charge on the counterion X′″. For example, when X′″ is r will be 1, i.e. the salt will be HCl.

If present, particularly preferred acids for use in the DMC catalyst of the present invention having the formula HᵣX′″ include the following: HCl, H₂SO₄, HNO₃, H₃PO₄, HF, HI, HBr, H₃BO₃ and HClO₄. HCl, HBr and H₂SO₄ are particularly preferred.

It will also be appreciated that an alkali metal salt (e.g. an alkali metal hydroxide such as KOH, an alkali metal oxide or an alkali metal carbonate) may be added to the reaction mixture during synthesis of the DMC catalyst. For example, the alkali metal salt may be added to the reaction mixture after the metal salt (M′(X′)ₚ) has been added to the metal cyanide salt ((Y)q[M″(CN)_{b}(A)_{c}]).

In one common preparation, an aqueous solution of zinc chloride (excess) is mixed with an aqueous solution of potassium hexacyanocobaltate, and a complexing agent (such as dimethoxyethane or tert-butyl alcohol) is added to the resulting slurry. After filtration and washing of the catalyst with an aqueous solution of the complexing agent (e.g. aqueous dimethoxyethane or aqueous tert-butyl alcohol), an active catalyst is obtained. Subsequent washing step(s) may be carried out using just the complexing agent, in order to remove excess water. Each one is followed by a filtration step.

In an alternative preparation, several separate solutions may be prepared and then combined in order. For example, the following solutions may be prepared:
1. a solution of a metal cyanide (e.g. potassium hexacyanocobaltate)
2. a solution of a metal salt e.g. (zinc chloride (excess))
3. a solution of a first complexing agent (e.g. PPG diol)
4. a solution of a second complexing agent (e.g. tert-butyl alcohol).

In this method, solutions 1 and 2 are combined immediately, followed by slow addition of solution 4, preferably whilst stirring rapidly. Solution 3 may be added once the addition of solution 4 is complete, or shortly thereafter. The catalyst is removed from the reaction mixture via filtration, and is subsequently washed with a solution of the complexing agents.

If water is desired in the DMC catalyst, then the above solutions (e.g. solutions 1 to 4) may be aqueous solutions.

However, it will be understood that anhydrous DMC catalysts (i.e. DMC catalysts without any water present) may be prepared if the solutions described in the above preparations are anhydrous solutions. To avoid hydrating the DMC catalyst and thereby introducing water molecules, any further processing steps (washing, filtration etc.) may be conducted using anhydrous solvents.

In one common preparation, several separate solutions may be prepared and then combined in order. For example, the following solutions may be prepared:
1. a solution of a metal salt (e.g. zinc chloride (excess)) and a second complexing agent (e.g. tert-butyl alcohol)
2. a solution of a metal cyanide (e.g. potassium hexacyanocobaltate)
3. a solution of a first and a second complexing agent. The first complexing agent may be a polymer (e.g. polypropylene glycol diol). The second complexing agent may be tert-butyl alcohol.

In this method, solutions 1 and 2 are combined slowly (e.g. over 1 hour) at a raised temperature (e.g. above 25° C., such as about 50° C.) while stirring (e.g. at 450 rpm). After addition is complete the stirring rate is increased for 1 hour (e.g. up to 900 rpm). The stirring rate is then decreased to a slow rate (e.g. to 200 rpm) and solution 3 is added quickly with low stirring. The mixture is filtered. The catalyst solids may be re-slurried in a solution of the second complexing agent at high stirring rate (e.g. about 900 rpm) before addition of the first complexing agent at low stirring rate (e.g. 200 rpm). The mixture is then filtered. This step may be repeated more than once. The resulting catalyst cake may be dried under vacuum (with heating e.g. to 60° C.).

Alternatively, after the mixture is first filtered it can be re-slurried at a raised temperature (e.g. above 25° C., such as about 50° C.) in a solution of the first complexing agent (and no second or further complexing agent) and then homogenized by stirring. It is then filtered after this step. The catalyst solids are then re-slurried in a mixture of the first and second complexing agents. For example, the catalyst solids are re-slurried in the second complexing agent at a raised temperature (e.g above 25° C., such as about 50° C.) and subsequently the first complexing agent is added and mixture homogenized by stirring. The mixture is filtered and the catalyst is dried under vacuum with heating (e.g. to 100° C.).

It will be appreciated that the DMC catalyst may comprise:

M′_{d}[M″ₑ(CN)_{f}]_{g}

wherein M′ and M″ are as defined above, d, e, f and g are integers, and are chosen to such that the DMC catalyst has electroneutrality. Preferably, d is 3. Preferably, e is 1. Preferably f is 6. Preferably g is 2. Preferably, M′ is selected from Zn(II), Fe(II), Co(II) and Ni(II), more preferably M′ is Zn(II). Preferably M″ is selected from Co(III), Fe(III), Cr(III) and Ir(III), more preferably M″ is Co(III).

It will be appreciated that any of these preferred features may be combined, for example, d is 3, e is 1, f is 6 and g is 2, M′ is Zn(II) and M″ is Co(III).

Suitable DMC catalysts of the above formula may include zinc hexacyanocobaltate(III), zinc hexacyanoferrate(III), nickel hexacyanoferrate(II), and cobalt hexacyanocobaltate(III).

There has been a lot of development in the field of DMC catalysts, and the skilled person will appreciate that the DMC catalyst may comprise, in addition to the formula above, further additives to enhance the activity of the catalyst. Thus, while the above formula may form the “core” of the DMC catalyst, the DMC catalyst may additionally comprise stoichiometric or non-stoichiometric amounts of one or more additional components, such as at least one complexing agent, an acid, a metal salt, and/or water.

For example, the DMC catalyst may have the following formula:

M′_{d}[M″ₑ(CN)_{f}]_{g}.hM′″X″ᵢ.jR^{c}.kH₂O.lHᵣX′″

wherein M′, M″, X′″, d, e, f and g are as defined above. M″ can be M′ and/or M″. X″ is an anion selected from halide, oxide, hydroxide, sulphate, carbonate, cyanide, oxalate, thiocyanate, isocyanate, isothiocyanate, carboxylate and nitrate, preferably X″ is halide. i is an integer of 1 or more, and the charge on the anion X″ multiplied by i satisfies the valency of M″. r is an integer that corresponds to the charge on the counterion X′″. For example, when X′″ is Cl⁻, r will be 1. l is 0, or a number between 0.1 and 5. Preferably, l is between 0.15 and 1.5.

R^{c} is a complexing agent, and may be as defined above. For example, R^{c} may be a (poly)ether, a polyether carbonate, a polycarbonate, a poly(tetramethylene ether diol), a ketone, an ester, an amide, an alcohol (e.g. a C₁₋₈ alcohol), a urea and the like, such as propylene glycol, polypropylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol, for example, R^{c} may be tert-butyl alcohol, dimethoxyethane, or polypropylene glycol.

As indicated above, more than one complexing agent may be present in the DMC catalysts used in the present invention. A combination of the complexing agents tert-butyl alcohol and polypropylene glycol is particularly preferred.

It will be appreciated that if the water, complexing agent, metal salt and/or acid are not present in the DMC catalyst, h, j, k and/or l will be zero respectively. If the water, complexing agent, acid and/or metal salt are present, then h, j, k and/or l are a positive number and may, for example, be between 0 and 20. For example, h may be between 0.1 and 4. j may be between 0.1 and 6. k may be between 0 and 20, e.g. between 0.1 and 10, such as between 0.1 and 5. l may be between 0.1 and 5, such as between 0.15 and 1.5.

As set out above, DMC catalysts are complicated structures, and thus, the above formula including the additional components is not intended to be limiting. Instead, the skilled person will appreciate that this definition is not exhaustive of the DMC catalysts which are capable of being used in the invention.

An exemplary DMC catalyst is of the formula Zn₃[Co(CN)₆]₂.hZnCl₂.kH₂O. j[(CH₃)₃COH], wherein h, k and l are as defined above. For example, h may be from 0 to 4 (e.g. from 0.1 to 4), k may be from 0 to 20 (e.g. from 0.1 to 10), and j may be from 0 to 6 (e.g. from 0.1 to 6).

### Starter Compound

The starter compound which may be used in the method of the invention comprises at least two groups selected from a hydroxyl group (—OH), a thiol (—SH), an amine having at least one N—H bond (—NHR′), a group having at least one P—OH bond (e.g. —PR′(O)OH, PR′(O)(OH)₂ or —P(O)(OR′)(OH)), or a carboxylic acid group (—C(O)OH).

Thus, the starter compound which is useful in the method of the invention may be of the formula (III):

Z—R^{Z})ₐ (III)

Z can be any group which can have 2 or more —R^{Z} groups attached to it. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group. Preferably Z is alkylene, heteroalkylene, arylene, or heteroarylene.

It will be appreciated that a is an integer which is at least 2, preferably a is in the range of between 2 and 8, preferably a is in the range of between 2 and 6.

Each R^{Z} may be —OH, —NHR′, —SH, —C(O)OH, —P(O)(OR′)(OH), —PR′(O)(OH)₂ or —PR′(O)OH, preferably R^{Z} is selected from —OH, —NHR′ or —C(O)OH, more preferably each R^{z} is —OH, —C(O)OH or a combination thereof (e.g. each R^{z} is —OH).

R′ may be H, or optionally substituted alkyl, heteroalkyl, aryl, heteroaryl, cycloalkyl or heterocycloalkyl, preferably R′ is H or optionally substituted alkyl.

It will be appreciated that any of the above features may be combined. For example, a may be between 2 and 8, each R^{Z} may be —OH, —C(O)OH or a combination thereof, and Z may be selected from alkylene, heteroalkylene, arylene, or heteroarylene.

Exemplary starter compounds include diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4-OH groups, polyols, such as sorbitol or polyalkylene glycols (PEGs or PPGs) having 5 or more —OH groups, or compounds having mixed functional groups including ethanolamine, diethanolamine, methyldiethanolamine, and phenyldiethanolamine.

For example, the starter compound may be a diol such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, poly(caprolactone) diol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like. It will be appreciated that the starter compound may be 1,6-hexanediol, 1,4-cyclohexanedimethanol, 1,12-dodecanediol, poly(caprolactone) diol, PPG 425, PPG 725, or PPG 1000.

Further exemplary starter compounds may include diacids such as oxalic acid, malonic acid, succinic acid, glutaric acid, adipic acid, pimelic acid, suberic acid, azelaic acid, sebacic acid, undecanedioic acid, dodecanedioic acid or other compounds having mixed functional groups such as lactic acid, glycolic acid, 3-hydroxypropanoic acid, 4-hydroxybutanoic acid, 5-hydroxypentanoic acid.

### Reaction Conditions

The method of the invention may be carried out at pressures of between about 1 bar and about 20 bar carbon dioxide, e.g. between about 1 bar and about 15 bar (absolute) carbon dioxide.

The method of the invention may be carried out in the presence of a solvent, however it will also be appreciated that the reaction may be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc. Preferred solvents, if present, include hexane, toluene, ethyl acetate, acetone and n-butyl acetate.

The epoxide which is used in the method may be any containing an epoxide moiety. Exemplary epoxides include ethylene oxide, propylene oxide, butylene oxide and cyclohexene oxide.

The epoxide may be purified (for example by distillation, such as over calcium hydride) prior to reaction with carbon dioxide. For example, the epoxide may be distilled prior to being added to the reaction mixture comprising the catalysts.

The process may be carried out at a temperature of about 0° C. to about 250° C., for example from about 0° C. to about 250° C., for example from about 5° C. to about 200° C., e.g. from about 10° C. to about 150° C., such as from about 15° C. to about 100° C., for example, from about 20° C. to about 80° C. It is particularly preferred that the method of the invention is carried out at from about 40° C. to about 80° C.

The duration of the process may be up to about 168 hours, such as from about 1 minute to about 24 hours, for example from about 5 minutes to about 12 hours, e.g. from about 1 to about 6 hours.

The method of the invention may be carried out at low catalytic loading. For example, the catalytic loading of the catalyst of formula (I) may be in the range of about 1:100,000-300,000 [catalyst of formula (I)]:[epoxide], such as about 1:10,000-100,000 [catalyst of formula (I)]:[epoxide], e.g. in the region of about 1:10,000-50,000 [catalyst of formula (I)]:[epoxide], for example in the region of about 1:10,000 [catalyst of formula (I)]:[epoxide]. The ratios above are molar ratios.

The ratio of the catalyst of formula (I) to the DMC catalyst may be in the range of from about 300:1 to about 1:100, for example, from about 120:1 to about 1:75, such as from about 40:1 to about 1:50, e.g. from about 30:1 to about 1:30 such as from about 20:1 to about 1:1, for example from about 10:1 to about 2:1, e.g. from about 5:1 to about 1:5. These ratios are mass ratios.

The starter compound may be present in amounts of from about 1000:1 to about 1:1, for example, from about 750:1 to about 5:1, such as from about 500:1 to about 10:1, e.g. from about 250:1 to about 20:1, or from about 125:1 to about 30:1, or from about 50:1 to about 20:1, relative to the catalyst of formula (I). These ratios are molar ratios.

The starter may be pre-dried (for example with molecular sieves) to remove moisture. It will be understood that any of the above reaction conditions described may be combined. For example, the reaction may be carried out at 20 bar or less (e.g. 10 bar or less) and at a temperature in the range of from about 5° C. to about 200° C., e.g. from about 10° C. to about 150° C., such as from about 15° C. to about 100° C., for example, from about 20° C. to about 80° C. It is particularly preferred that the method of the invention is carried out at from about 40° C. to about 80° C.

The method may be a batch reaction, a semi-continuous reaction, or a continuous reaction.

### Polyols

The method of the invention is capable of preparing polycarbonate ether polyols, which are capable of being used, for example, to prepare polyurethanes.

The method of the invention is capable of producing polycarbonate ether polyols in which the amount of ether and carbonate linkages can be controlled. Thus, the invention provides a polycarbonate ether polyol which has n ether linkages and m carbonate linkages, wherein n and m are integers, and wherein m/(n+m) is from greater than zero to less than 1. It will therefore be appreciated that n 1 and m 1.

For example, the method of the invention is capable of preparing polycarbonate ether polyols having a wide range of m/(n+m) values. It will be understood that m/(n+m) may be about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.05 to about 0.95, from about 0.10 to about 0.90, from about 0.15 to about 0.85, from about 0.20 to about 0.80, or from about 0.25 to about 0.75, etc.

As set out above, the process of the invention is capable of preparing polycarbonate ether polyols where m/(n+m) is from about 0.7 to about 0.95, e.g. from about 0.75 to about 0.95.

Thus, the method of the invention makes it possible to prepare polycarbonate ether polyols having a high proportion of carbonate linkages, e.g. m/(n+m) may be greater than about 0.50, such as from greater than about 0.55 to less than about 0.95, e.g. about 0.65 to about 0.90, e.g. about 0.75 to about 0.90.

For example, the polycarbonate ether polyols produced by the method of the invention may have the following formula (IV):

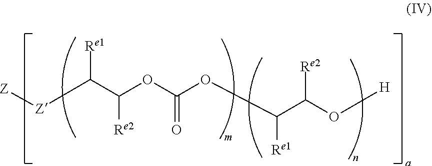

It will be appreciated that the identity of Z and Z′ will depend on the nature of the starter compound, and that the identity of R^{e1} and R^{e2} will depend on the nature of the epoxide used to prepare the polycarbonate ether polyol. m and n define the amount of the carbonate and ether linkages in the polycarbonate ether polyol.

The skilled person will understand that in the polymers of formula (IV), the adjacent epoxide monomer units in the backbone may be head-to-tail linkages, head-to-head linkages or tail-to-tail linkages.

It will also be appreciated that formula (IV) does not require the carbonate links and the ether links to be present in two distinct “blocks” in each of the sections defined by “a”, but instead the carbonate and ether repeating units may be statistically distributed along the polymer backbone, or may be arranged so that the carbonate and ether linkages are not in two distinct blocks.

Thus, the polycarbonate ether polyol prepared by the method of the invention (e.g. a polymer of formula (IV)) may be referred to as a random copolymer, a statistical copolymer, an alternating copolymer, or a periodic copolymer.

The skilled person will appreciate that the wt % of carbon dioxide incorporated into a polymer cannot be definitively used to determine the amount of carbonate linkages in the polymer backbone. For example, two polymers which incorporate the same wt % of carbon dioxide may have very different ratios of carbonate to ether linkages. This is because the “wt % incorporation” of carbon dioxide does not take into account the length and nature of the starter compound. For instance, if one polymer (Mn 2000 g/mol) is prepared using a starter with a molar mass of 100 g/mol, and another polymer (Mn also 2000 g/mol) is prepared using a starter having a molar mass of 500 g/mol, and both the resultant polymers have the same ratio of m/n then the wt % of carbon dioxide in the polymers will be different due to the differing proportion of the mass of the starter in the overall polymer molecular weight (Mn). For example, if m/(m+n) was 0.5, the two polyols described would have carbon dioxide contents of 26.1 wt % and 20.6 wt % respectively.

As highlighted above, the method of the invention is capable of preparing polyols which have a wide range of carbonate to ether linkages (e.g. m/(n+m) can be from greater than zero to less than 1), which, when using propylene oxide, corresponds to incorporation of up to about 43 wt % carbon dioxide. This is surprising, as DMC catalysts which have previously reported can generally only prepare polyols having a ratio of carbonate to ether linkages of up to 0.75, and these amounts can usually only be achieved at high pressures of carbon dioxide, such as 30 bar, more commonly 40 bar or above.

Furthermore, catalysts which are used to prepare polycarbonate polyols can typically achieve a ratio of carbonate to ether linkages of about 0.95 or above (usually about 0.98 or above), and thus also incorporate a high wt % of carbon dioxide. However, these catalysts are not capable of preparing polyols having a ratio of carbonate to ether linkages below 0.95. The carbon dioxide wt % can be moderated by changing the mass of the starter: the resultant polyols contain blocks of polycarbonate. For many applications this is not desirable, as polycarbonates produced from epoxides and carbon dioxide are less thermally stable than polyethers and block copolymers can have very different properties from random or statistical copolymers.

All other things being equal, polyethers have higher temperatures of degradation than polycarbonates produced from epoxides and carbon dioxide. Therefore, a polyol having a statistical or random distribution of ether and carbonate linkages will have a higher temperature of degradation than a polycarbonate polyol, or a polyol having blocks of carbonate linkages. Temperature of thermal degradation can be measured using thermal gravimetric analysis (TGA).

As set out above, the method of the invention prepares a random copolymer, a statistical copolymer, an alternating copolymer, or a periodic copolymer. Thus, the carbonate linkages are not in a single block, thereby providing a polymer which has improved properties, such as improved thermal degradation, as compared to a polycarbonate polyol. Preferably, the polymer prepared by the method of the invention is a random copolymer or a statistical copolymer.

The polycarbonate ether polyol prepared by the method of the invention may be of formula (IV), in which n and m are integers of 1 or more, the sum of all m and n groups is from 4 to 200, and wherein m/(m+n) is in the range of from greater than zero to less than 1.00. As set out above, m/(n+m) may be from about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.05 to about 0.95, from about 0.10 to about 0.90, from about 0.15 to about 0.85, from about 0.20 to about 0.80, or from about 0.25 to about 0.75, etc.

The skilled person will also appreciate that the polyol must contain at least one carbonate and at least one ether linkage. Therefore it will be understood that the number of ether and carbonate linkages (n+m) in the polyol will be a. The sum of n+m must be greater than or equal to “a”.

Each R^{e1} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. Preferably R^{e1} may be selected from H or optionally substituted alkyl.

Each R^{e2} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. Preferably R^{e2} may be selected from H or optionally substituted alkyl.

It will also be appreciated that R^{e1} and R^{e2} may together form a saturated, partially unsaturated or unsaturated ring containing carbon and hydrogen atoms, and optionally one or more heteroatoms (e.g. O, N or S). For example, R^{e1} and R^{e2} may together form a 5 or six membered ring.

As set out above, the nature of R^{e1} and R^{e2} will depend on the epoxide used in the reaction. If the epoxide is cyclohexene oxide (CHO), then R^{e1} and R^{e2} will together form a six membered alkyl ring (e.g. a cyclohexyl ring). If the epoxide is ethylene oxide, then R^{e1} and R^{e2} will both be H. If the epoxide is propylene oxide, then R^{e1} will be H and R^{e2} will be methyl (or R^{e1} will be methyl and R^{e2} will be H, depending on how the epoxide is added into the polymer backbone). If the epoxide is butylene oxide, then R^{e1} will be H and R^{e2} will be ethyl (or vice versa). If the epoxide is styrene oxide, then R^{e1} may be hydrogen, and R^{e2} may be phenyl (or vice versa).

It will also be appreciated that if a mixture of epoxides are used, then each occurrence of R^{e1} and/or R^{e2} may not be the same, for example if a mixture of ethylene oxide and propylene oxide are used, R^{e1} may be independently hydrogen or methyl, and R^{e2} may be independently hydrogen or methyl.

Thus, R^{e1} and R^{e2} may be independently selected from hydrogen, alkyl or aryl, or R^{e1} and R^{e2} may together form a cyclohexyl ring, preferably R^{e1} and R^{e2} may be independently selected from hydrogen, methyl, ethyl or phenyl, or R^{e1} and R^{e2} may together form a cyclohexyl ring.

Z′ corresponds to R^{z}, except that a bond replaces the labile hydrogen atom. Therefore, the identity of each Z′ depends on the definition of R^{Z} in the starter compound. Thus, it will be appreciated that each Z′ may be —O—, —NR′—, —S—, —C(O)O—, —P(O)(OR′)O—, —PR′(O)(O—)₂ or —PR′(O)O— (wherein R′ may be H, or optionally substituted alkyl, heteroalkyl, aryl, heteroaryl, cycloalkyl or heterocycloalkyl, preferably R′ is H or optionally substituted alkyl), preferably Z′ may be —C(O)O—, —NR′— or —O—, more preferably each Z′ may be —O—, —C(O)O— or a combination thereof, more preferably each Z′ may be —O—.

Z also depends on the nature of the starter compound. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group. Preferably Z is alkylene, heteroalkylene, arylene, or heteroarylene, e.g. alkylene or heteroalkylene. It will be appreciated that each of the above groups may be optionally substituted, e.g. by alkyl.

The variable a will also depend on the nature of the starter compound. The skilled person will appreciate that the value of a in formula (IV) will be the same as a in formula (III). Therefore, for formula (IV), a is an integer of at least 2, preferably a is in the range of between 2 and 8, preferably a is in the range of between 2 and 6.

The skilled person will also appreciate that the value of a will influence the shape of the polyol prepared by the method of the invention. For example, when a is 2, the polyol of formula (IV) may have the following structure:

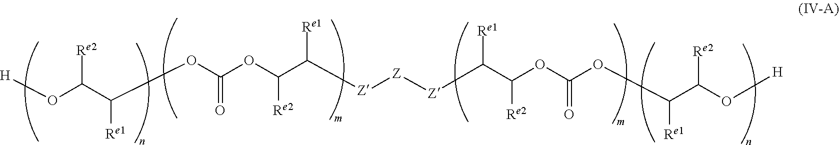

where Z, Z′, m, n, R^{e1} and R^{e2} are as described above for formula (IV).

For example, when a is 3, the polyol of formula (IV) may have the following formula:

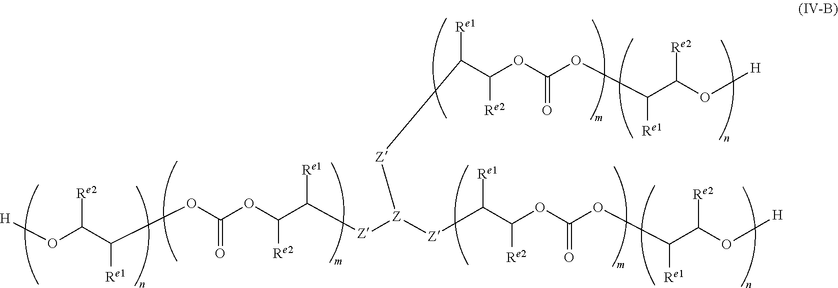

where Z, Z′, m, n, R^{e1} and R^{e2} are as described above for formula (IV).

The skilled person will understand that each of the above features may be combined. For example, R^{e1} and R^{e2} may be independently selected from hydrogen, alkyl or aryl, or R^{e1} and R^{e2} may together form a cyclohexyl ring, each Z′ may be —O—, —C(O)O— or a combination thereof (preferably each Z′ may be —O—), and Z may be optionally substituted alkylene, heteroalkylene, arylene, or heteroarylene, e.g. alkylene or heteroalkylene, and a may be between 2 and 8.

The polyols produced by the method of the invention are preferably low molecular weight polyols. It will be appreciated that the nature of the epoxide used to prepare the polycarbonate ether polyol will have an impact on the resulting molecular weight of the product. Thus, the upper limit of n+m is used herein to define “low molecular weight” polymers of the invention.

The method of the invention can advantageously prepare a polycarbonate ether polyol having a narrow molecular weight distribution. In other words, the polycarbonate ether polyol may have a low polydispersity index (PDI). The PDI of a polymer is determined by dividing the weight average molecular weight (M_{w}) by the number average molecular weight (Mₙ) of a polymer, thereby indicating the distribution of the chain lengths in the polymer product. It will be appreciated that PDI becomes more important as the molecular weight of the polymer decreases, as the percent variation in the polymer chain lengths will be greater for a short chain polymer as compared to a long chain polymer, even if both polymers have the same PDI.

Preferably the polymers produced by the method of the invention have a PDI of from about 1 to less than about 2, preferably from about 1 to less than about 1.75, more preferably from about 1 to less than about 1.5, even more preferably from about 1 to less than about 1.3.

The Mₙ and M_{w}, and hence the PDI of the polymers produced by the method of the invention may be measured using Gel Permeation Chromatography (GPC). For example, the GPC may be measured using an Agilent 1260 Infinity GPC machine with two Agilent PLgel μ-m mixed-E columns in series. The samples may be measured at room temperature (293K) in THF with a flow rate of 1 mL/min against narrow polystyrene standards (e.g. polystyrene low EasiVials supplied by Agilent Technologies with a range of Mn from 405 to 49,450 g/mol). Optionally, the samples may be measured against poly(ethylene glycol) standards, such as polyethylene glycol easivials supplied by Agilent Technologies.

Preferably, the polymers produced by the method of the invention may have a molecular weight in the range of from about 500 to about 6,000 Da, preferably from about 700 to about 5,000 Da or from about 500 to about 3,000 Da.

The invention also provides a polymerisation system for the copolymerisation of carbon dioxide and an epoxide, comprising:
d. a catalyst of formula (I) as defined herein,
e. a DMC catalyst as defined herein, and
f. a starter compound as herein.

It will also be appreciated that the polyols prepared by the method of the invention may be used for further reactions, for example to prepare a polyurethane, for example by reacting a polyol composition comprising a polyol prepared by the method of the invention with a composition comprising a di- or polyisocyanate.

### EXAMPLES

### Methods

### ¹H NMR Analysis

The assessment of polyether and polycarbonate content of the polyethercarbonate polyols has been reported in a number of different ways. In order to calculate the molar carbonate content and the CO₂ wt % in the polyethercarbonate polyols, the method described in US2014/0323670 was used herein. The method is as follows:

The samples were dissolved in deuterated chloroform and measured on a Bruker spectrometer. The relevant resonances in the ¹H-NMR spectra used for integration (in the case that 1,6-hexanediol is used as a starter) were:

TABLE A

| ¹H NMR | | |
|---|---|---|
| resonance | Protons from repeating | No of |
| (ppm) | units | protons |
| A (1.08-1.18) | CH₃ of Polyether | 3 |
| B (1.18-1.25) | CH₃ of Polycarbonate | 3 |
| | end groups | |
| C (1.25-1.38) | CH₃ of Polycarbonates | 3 |
| D (1.45-1.49) | CH₃ of cyclic carbonate | 3 |
| E (1.64-1.75) | CH₂ of hexanediol | 4 |
| or (1.40-1.48) | | |
| F (2.95-2.99) | CH of propylene oxide | 1 |

The resonances A, C-F have been previously defined for polyethercarbonates containing a low proportion of carbonate linkages in the methods described in US2014/0323670. An extra resonance (B, 1.18-1.25 ppm) has been identified that is only present in significant quantities in polyethercarbonates with a high carbonate content. It has been assigned (by 2D NMR) as a terminal propylene CH₃ group between a carbonate unit and a hydroxyl end group. It is therefore added to the total carbonate units (C) as described in US2014/0323670.

Carbonate/ether ratio (m/n+m): molar ratio of carbonate and ether linkages:

$$\frac{m}{n + m} = {R}_{C} = \frac{B + C}{A + B + C} \qquad ( Equation 1 )$$

CO₂ wt % in polyol: amount of CO₂ incorporated into the total polyol:

$$CO 2 wt \% = \frac{( C + B ) \times 44}{( A \times 58 ) + ( ( B + C ) \times 102 ) + ( 0.75 \times ( E \times 118 ) )} \times 100 \qquad ( Equation 2 )$$

Wherein 44 is the mass of CO₂ within a carbonate unit, 58 is the mass of a polyether unit, 102 is the mass of a polycarbonate unit and 118 is the mass of the hexanediol starter (the factor 0.75 is added as the hexanediol resonance corresponds to 4 protons whilst all the other resonances correspond to 3). This is the total proportion of CO₂ that is present in the entire polyol. If other starters are used it is appreciated the relevant NMR signals, relative integrations and molecular weights will be used in the calculation.

Furthermore, resonance C can be broken down into two different resonances. From 1.26-1.32 ppm (C¹) corresponds to the propylene CH₃ in a polymer unit between a carbonate and an ether linkage (a polyethercarbonate, PEC linkage) whilst the resonance from 1.32-1.38 ppm (C²) comes from a propylene CH₃ in a polymer unit in between two carbonate linkages (a polycarbonate, PC linkage). The ratio of PEC, PC and PE linkages gives an indication of the structure of the polymer. A completely blocked structure will contain very few PEC linkages (only those at the block interfaces), whilst a more random structure will include a significant proportion of PEC linkages where both polyether and polycarbonate units are adjacent to each other in the polymer backbone. The ratio of these two units gives an indication of the structure.

Polyethercarbonate/polycarbonate linkage ratio:

$${R}_{PEC} = \frac{{C}^{1}}{{C}^{1} + {C}^{2}} \qquad ( Equation 3 )$$

### Gel Permeation Chromatography

GPC measurements were carried out against narrow polydispersity poly(ethylene glycol) or polystyrene standards in THF using an Agilent 1260 Infinity machine equipped with Agilent PLgel Mixed-E columns.

### Example 1

### Synthesis of DMC Catalyst 1

The DMC catalyst used in this example was prepared according to the method reported in Journal of Polymer Science; Part A: Polymer Chemistry, 2002, 40, 1142. In brief, 1.0 g of K₃Co(CN)₆ was dissolved in a mixture solvent of 13 g distilled water and 2 g tert-butyl alcohol. 6 g of ZnCl₂ was dissolved in a mixture solvent of 13 g water and 4 g tert-butyl alcohol, and then this mixture was added slowly to the K₃Co(CN)₆ solution over a period of 20 minutes, whilst stirring. The mixture was then stirred for a further 40 minutes and then centrifugal separation was performed to yield a white precipitate. The precipitate was dispersed in a mixture solvent of 16 g water and 16 g tert-butyl alcohol, and stirred for 20 minutes, and then the precipitate was separated by centrifuge. This washing procedure was repeated 3 times. The white precipitate was then dispersed in 50 g tert-butyl alcohol, and then stirred for 20 minutes, followed by centrifugal separation to obtain a white precipitate. The washing with tert-butyl alcohol was then repeated once more. The solvent was then removed under reduced pressure at 60° C. for 8 hours. The resultant compound is understood to have the formula Zn₃[Co(CN)₆]₂.hZnCl₂.0.5H₂O.2[(CH₃)₃COH].

### Example 2

### Synthesis of Catalyst 2

Catalyst 2 was synthesised as per A. Cyriac et al, Macromolecules, 2010, 43 (18), 7398-7401.

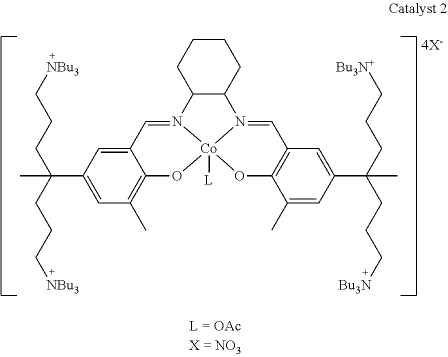

### Example 3

a. Copolymerisation of Propylene Oxide (PO) and CO₂ in the Presence of a Chain Transfer Agent (Starter) Using DMC Catalyst 1 and Catalyst 2

1,6-hexanediol (0.30 g) and DMC catalyst 1 (0.005 g) were dried prior to copolymerisation in the reactor at 100° C. for 0.5 hours under vacuum. The autoclave was then allowed to cool to ambient temperature before charging with a solution of catalyst 2 (0.072 g) in PO (15 mL). The autoclave was then pressurised with 2 bar CO₂ and allowed to heat to 70° C. Upon stabilisation of the autoclave at the desired temperature, the autoclave was pressurised to 20 bar CO₂ pressure stirred at 800 rpm for the requisite time. After 16 hours the reaction was terminated by cooling the reactor to 5° C. and vented slowly. The crude polyol was analysed by ¹H NMR spectroscopy and Gel Permeation Chromatography.

The polymer was found to contain ˜97% carbonate linkages. The polyol produced by catalyst 2 alone is known to be >99% selective for polycarbonate formation. The polyol produced in this Example has a molecular weight (Mn) of 950 with a polydispersity index (PDI) of 1.41. The polymers produced by catalyst 2 alone are known to have PDI of <1.2. Both of these factors demonstrate that the two catalysts perform together to produce a polyethercarbonate polyol, and thus provide a proof of concept for the present invention.

b. Copolymerisation of Propylene Oxide (PO) and CO₂ in the Presence of a Chain Transfer Agent (Starter) Using DMC Catalyst 1 and Catalyst 2

1,6-hexanediol (0.25 g) and DMC catalyst 1 (0.005 g) were dried prior to copolymerisation in the reactor at 100° C. for 0.5 hours under vacuum. The autoclave was then allowed to cool to ambient temperature before charging with a solution of catalyst 2 (0.036 g) in PO (15 mL). The autoclave was then pressurised with 2 bar CO₂ and allowed to heat to 70° C.

Upon stabilisation of the autoclave at the desired temperature, the autoclave was pressurised to 20 bar CO₂ pressure stirred at 800 rpm for the requisite time. After 16 hours the reaction was terminated by cooling the reactor to 5° C. and vented slowly. The crude polyol was analysed by ¹H NMR spectroscopy and Gel Permeation Chromatography.

The polymer was found to contain ˜80% carbonate linkages. The polyol produced by catalyst 2 alone is known to be >99% selective for polycarbonate formation. The polyol produced in this Example has a molecular weight (Mn) of 700 with a polydispersity index (PDI) of 1.27. The polymers produced by catalyst 2 alone are known to have PDI of <1.2. Both these factors demonstrate that the two catalysts perform together to produce a polyethercarbonate polyol, and thus provide a proof of concept for the present invention.

### Example 4

### Synthesis of DMC Catalyst 3

The synthesis described in Example 1 of U.S. Pat. No. 5,482,908 was followed except the 4000 molecular weight polypropylene glycol diol was replaced with a 2000 molecular weight polypropylene glycol diol:

Potassium hexacyanocobaltate (8.0 g) was dissolved in deionised (DI) water (140 mL) in a beaker (solution 1). Zinc chloride (25 g) was dissolved in DI water (40 mL) in a second beaker (solution 2). A third beaker containing solution 3 was prepared: a mixture of DI water (200 mL), tert-butyl alcohol (2 mL) and polyol (2 g of a 2000 mol. wt. polypropylene glycol diol). Solutions 1 and 2 were mixed together using a mechanical stirrer. Immediately a 50/50 (by volume) mixture of tert-butyl alcohol and DI water (200 mL total) was added to the zinc hexacyanocobaltate mixture, and the product was stirred vigorously for 10 min. Solution 3 (polyol/water/tert-butyl alcohol mixture) was added to the aqueous slurry of zinc hexacyanocobaltate and the product stirred magnetically for 3 min. The mixture was filtered under pressure to isolate the solids. The solid cake was reslurried in tert-butyl alcohol (140 mL), DI water (60 mL), and an additional 2 g of the 2000 mol. wt. polypropylene glycol diol. Then mixture was stirred vigorously for 10 min. and filtered. The solid cake was reslurried in tert-butyl alcohol (200 mL) and an additional 1 g of 2000 mol. wt. polypropylene glycol diol and stirred vigorously for 10 minutes, then filtered. The resulting solid catalyst was dried under vacuum (<1 mbar) at 50° C. to constant weight. The yield of dry, powdery catalyst was 8.5 g.

### Comparative Example 5

### Copolymerisation of PO and CO₂ in the Presence of a Chain Transfer Agent (Starter) Using DMC Catalyst 3

1,12-Dodecanediol (0.826 g) and 3 mg of the DMC catalyst 3 were taken into a 100 mL reactor and dried at 120° C. under vacuum for 1 hour prior to copolymerisation. The reactor vessel was cooled down to room temperature and a mixture of propylene oxide (10 mL, 143 mmol) and EtOAc (5 mL) was injected into the vessel via syringe under a continuous flow of CO₂. The vessel was heated to 50° C. and 5 bar of CO₂ pressure was added with continuous stirring at 600 rpm. The reaction was continued 50° C. for 4 hours before being raised to 80° C. The reaction was continued at 80° C. for 12 hours. Once the reaction was finished, the reactor was cooled to below 10° C. and the pressure released very slowly. NMR and GPC were measured immediately.

The propylene oxide conversion was 99%, the selectivity for polymer was 95% and the polymer produced contained 24% carbonate linkages (13.8 wt % CO₂) with an Mn of 2000 and a PDI of 1.46. The reaction was started at 50° C. to increase carbonate linkages and prevent an initial runaway reaction.

### Comparative Example 6

### Copolymerisation of PO and CO₂ in the Presence of a Chain Transfer Agent (Starter) Using Catalyst 4 and a Co-Catalyst

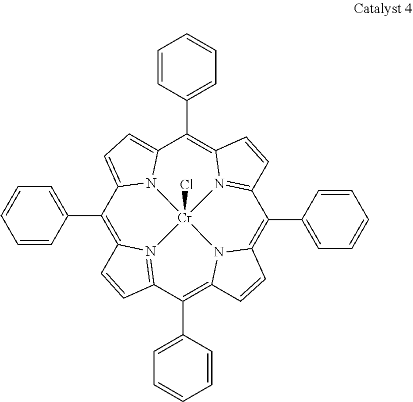

Catalyst 4 was purchased from Strem Chemicals UK. bis(triphenylphophoranylidene)ammonium chloride (PPNCl) was purchased from Strem.

1,12-Dodecanediol (0.826 g, 4.08 mmol) was taken into a 100 mL reactor and dried at 120° C. under vacuum for 1 hour prior to copolymerisation. The reactor vessel was cooled down to room temperature and a propylene oxide (10 mL, 143 mmol) solution of catalyst 4 (0.041 mmol), PPNCl (0.041 mmol) and EtOAc (5 mL) were injected into the vessel via syringe under a continuous flow of CO₂. The vessel was heated to 80° C. and 5 bar of CO₂ pressure was added with continuous stirring at 600 rpm. The reaction was continued at 80° C. for 16 hours. Once the reaction was finished, the reactor was cooled to below 10° C. and the pressure released very slowly. NMR and GPC were measured immediately.

The propylene oxide conversion was 70%, the selectivity for polymer was 70% and the polymer produced contained 88% carbonate linkages with an Mn of 1500 and a PDI of 1.09.

### Example 7

### Synthesis of DMC Catalyst 5

The DMC catalyst used in this example was prepared according to the method reported in European Polymer Journal, 2017, 88, 280-291, catalyst E. K₃[Co(CN)₆]₂ (0.77 g) was dissolved in 80 ml of mili-Q water and ZnCl₂ (1.77 g) in 210 ml of miliQ water and 50 ml of tBuOH. Both solutions were mixed and vigorously stirred 15 min at 50° C. After 13 min PEG 1000 was added to the mixed solution, the white suspension was centrifugated 6 min at 5000 rpm. The isolated slurry was resuspended with strong stirring during 20 min in 100 ml of t-BuOH: H₂O (50:50) solution and it was centrifugated as previous. The solid was resuspended in 100 ml of 100% t-BuOH and stirred for 30 min, filtered (omnipore PTFE membrane filter, 0.1 μm, Merck Milipore) and dried under vacuum at 50° C. during 30 h.

### Example 8

### Copolymerisation of PO and CO₂ in the Presence of a Chain Transfer Agent (Starter) Using a DMC Catalyst, Catalyst 4 and a Co-Catalyst

1,12-Dodecanediol (1.15 g) and 1.6 mg of the DMC catalyst 3 were taken into a 100 mL reactor and dried at 120° C. under vacuum for 1 hour prior to copolymerisation. The reactor vessel was cooled down to room temperature and a propylene oxide (20 mL, 286 mmol) solution of catalyst 4 (0.057 mmol), PPNCl (0.057 mmol) and EtOAc (10 mL) were injected into the vessel via syringe under a continuous flow of CO₂. The vessel was heated to 80° C. and 10 bar of CO₂ pressure was added with continuous stirring at 600 rpm. The reaction was continued at 80° C. for 16 hours. Once the reaction was finished, the reactor was cooled to below 10° C. and the pressure released very slowly. NMR and GPC were measured immediately.

The reaction with catalyst 4 gave 100% PO conversion with a selectivity for polymer of 94% and produced a polymer with 58% carbonate linkages (29.9 wt % CO₂) and an Mn of 3400. The reduction in carbonate linkages compared to catalyst 4 alone (comparative example 6) and increase compared to DMC catalyst 3 alone (comparative example 5) combined with the increased conversion demonstrates both catalysts perform together to produce a single polyol with moderated carbonate content. The reaction further demonstrates that under reduced catalyst loadings the reaction proceeds effectively and that balancing the catalyst loadings can be used to tune the CO₂ content.

### Example 9

### Copolymerisation of PO and CO₂ in the Presence of a Chain Transfer Agent (Starter) Using a DMC Catalyst, Catalyst 4 and a Co-Catalyst

1,12-Dodecanediol (5.77 g) and 6.9 mg of the DMC catalyst 3 were taken into a 100 mL reactor and dried at 120° C. under vacuum for 1 hour prior to copolymerisation. The reactor vessel was cooled down to room temperature and a propylene oxide (20 mL, 286 mmol) solution of catalyst 4 (0.082 mmol), PPNCl (0.082 mmol) and EtOAc (10 mL) were injected into the vessel via syringe under a continuous flow of CO₂. The vessel was heated to 70° C. and 5 bar of CO₂ pressure was added with continuous stirring at 600 rpm. The reaction was continued at 70° C. for 16 hours. Once the reaction was finished, the reactor was cooled to below 10° C. and the pressure released very slowly. NMR and GPC were measured immediately.

The reaction with catalyst 4 gave 100% PO conversion with a selectivity for polymer of 90% and produced a polymer with 58% carbonate linkages (24.3 wt % CO₂) and an Mn of 840 and a PDI of 1.04. The reaction demonstrates the dual catalyst system can be used to produce low molecular weight polyols with high CO₂ contents even in the presence of large amounts of starter.

### Example 10

### Copolymerisation of PO and CO₂ in the Presence of a Chain Transfer Agent (Starter) Using a DMC Catalyst, Catalyst 4 and a Co-Catalyst

1,12-Dodecanediol (1.15 g) and 2.4 mg of the DMC catalyst 5 were taken into a 100 mL reactor and dried at 120° C. under vacuum for 1 hour prior to copolymerisation. The reactor vessel was cooled to room temperature and a propylene oxide (20 mL, 286 mmol) solution of catalyst 4 (0.057 mmol), PPNCl (0.057 mmol) and EtOAc (10 mL) were injected into the vessel via syringe under a continuous flow of CO₂. The vessel was heated to 60° C. and 5 bar of CO₂ pressure was added with continuous stirring at 600 rpm. The reaction was continued at 60° C. for 16 hours. Once the reaction was finished, the reactor was cooled to below 10° C. and the pressure released very slowly. NMR and GPC were measured immediately.

The reaction with catalyst 4 gave 98% PO conversion with a selectivity for polymer of 96% and produced a polymer with 78% carbonate linkages (35.2 wt % CO₂) and an Mn of 3800. The reaction demonstrates the dual catalyst system can be used to produce polyols with high CO₂ contents, even under low pressures.

### Example 11

Propoxylated glycerol (Mn 260, 1.3 g) and 6.9 mg of the DMC catalyst 5 were taken into a 100 mL reactor and dried at 120° C. under vacuum for 1 hour prior to copolymerisation. The reactor vessel was cooled down to room temperature and a propylene oxide (20 mL, 286 mmol) solution of catalyst 4 (0.082 mmol), PPNCl (0.082 mmol) and EtOAc (10 mL) were injected into the vessel via syringe under a continuous flow of CO₂. The vessel was heated to 70° C. and 10 bar of CO₂ pressure was added with continuous stirring at 600 rpm. The reaction was continued at 70° C. for 16 hours. Once the reaction was finished, the reactor was cooled to below 10° C. and the pressure released very slowly. NMR and GPC were measured immediately.

The reaction with catalyst 4 gave 100% PO conversion with a selectivity for polymer of 96% and produced a polymer with 74% carbonate linkages (35.3 wt % CO₂) and an Mn of 5100. The reaction demonstrates the dual catalyst system can be used to produce triols with high CO₂ contents, even under low pressures.

### Example 12

Propoxylated glycerol (Mn 260, 1.3 g) and 6.9 mg of the DMC catalyst 5 were taken into a 100 mL reactor and dried at 120° C. under vacuum for 1 hour prior to copolymerisation. The reactor vessel was cooled down to room temperature and a propylene oxide (20 mL, 286 mmol) solution of catalyst 4 (0.082 mmol), PPNCl (0.082 mmol) and EtOAc (10 mL) were injected into the vessel via syringe under a continuous flow of CO₂. The vessel was heated to 60° C. and 5 bar of CO₂ pressure was added with continuous stirring at 600 rpm. The reaction was continued at 60° C. for 16 hours. Once the reaction was finished, the reactor was cooled to below 10° C. and the pressure released very slowly. NMR and GPC were measured immediately.

The reaction with catalyst 4 gave 100% PO conversion with a selectivity for polymer of 96% and produced a polymer with 77% carbonate linkages (36.2 wt % CO₂) and an Mn of 5200. The reaction further demonstrates the dual catalyst system can be used to produce triols with high CO₂ contents, even under low pressures.

### Example 13

### Copolymerisation of PO and CO₂ in the Presence of a Chain Transfer Agent (Starter) Using a DMC Catalyst, Catalyst 4 and a Co-Catalyst

1,12-Dodecanediol (1.65 g) and 2.3 mg of the DMC catalyst 5 were taken into a 100 mL reactor and dried at 120° C. under vacuum for 1 hour prior to copolymerisation. The reactor vessel was cooled to room temperature and a propylene oxide (20 mL, 286 mmol) solution of catalyst 4 (0.082 mmol), PPNCl (0.082 mmol) and EtOAc (10 mL) were injected into the vessel via syringe under a continuous flow of CO₂. The vessel was heated to 80° C. and 10 bar of CO₂ pressure was added with continuous stirring at 600 rpm. The reaction was continued at 80° C. for 16 hours. Once the reaction was finished, the reactor was cooled to below 10° C. and the pressure released very slowly. NMR and GPC were measured immediately.

The reaction gave 100% PO conversion with a selectivity for polymer of 90% and produced a polymer with 63% carbonate linkages (30.6 wt % CO₂) and an Mn of 2500.

### Comparative Example 14

### Copolymerisation of PO and CO₂ in the Presence of a Chain Transfer Agent (Starter) Using Catalyst 6 and a Co-Catalyst

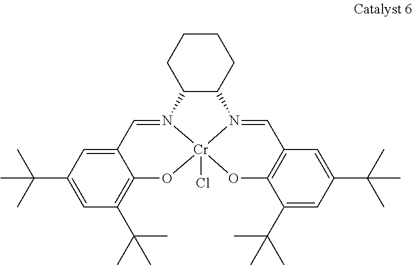

Catalyst 6 was purchased from Strem Chemicals UK.

1,12-Dodecanediol (0.826 g, 4.08 mmol) was taken into a 100 mL reactor and dried at 120° C. under vacuum for 1 hour prior to copolymerisation. The reactor vessel was cooled down to room temperature and a propylene oxide (10 mL, 143 mmol) solution of catalyst 6 (0.041 mmol), PPNCl (0.041 mmol) and EtOAc (5 mL) were injected into the vessel via syringe under a continuous flow of CO₂. The vessel was heated to 50° C. and 5 bar of CO₂ pressure was added with continuous stirring at 600 rpm. The reaction was continued at the set temperature for 16 hours. Once the reaction was finished, the reactor was cooled to below 10° C. and the pressure released very slowly. NMR and GPC were measured immediately.

At 50° C., the PO conversion was 32.9%, but the selectivity was 67% and the carbonate linkages 92%, producing a polymer with an Mn of 700 and a PDI of 1.09.

### Example 15

### Copolymerisation of PO and CO₂ in the Presence of a Chain Transfer Agent (Starter) Using a DMC Catalyst, Catalyst 6 and a Co-Catalyst

1,12-Dodecanediol (0.83 g) and 3 mg of the DMC catalyst 5 were taken into a 100 mL reactor and dried at 120° C. under vacuum for 1 hour prior to copolymerisation. The reactor vessel was cooled to room temperature and a propylene oxide (10 mL, 286 mmol) solution of catalyst 6 (0.041 mmol), PPNCl (0.041 mmol) and EtOAc (5 mL) were injected into the vessel via syringe under a continuous flow of CO₂. The vessel was heated to 65° C. and 10 bar of CO₂ pressure was added with continuous stirring at 600 rpm. The reaction was continued at 65° C. for 16 hours, however the CO₂ source was closed off after the initial feed of 10 bar pressure. Once the reaction was finished, the reactor was cooled to below 10° C. and the pressure released very slowly. NMR and GPC were measured immediately.

The reaction with catalyst 6 gave 99% PO conversion with 55% carbonate linkages (23.7 wt % CO₂), an Mn of 640 and a PDI of 1.08. The reaction demonstrates significant CO₂ incorporation under low pressures, even at temperatures above the optimum operating temperature of catalyst 6. The moderation of CO2 content demonstrates both catalysts worked together in tandem.

### Example 16

### Copolymerisation of PO and CO₂ in the Presence of a Chain Transfer Agent (Starter) Using a DMC Catalyst, Catalyst 6 and a Co-Catalyst

1,12-Dodecanediol (0.83 g) and 3 mg of the DMC catalyst 5 were taken into a 100 mL reactor and dried at 120° C. under vacuum for 1 hour prior to copolymerisation. The reactor vessel was cooled to room temperature and a propylene oxide (10 mL, 286 mmol) solution of catalyst 6 (0.041 mmol), PPNCl (0.041 mmol) and EtOAc (5 mL) were injected into the vessel via syringe under a continuous flow of CO₂. The vessel was heated to 60° C. and 10 bar of CO₂ pressure was added with continuous stirring at 600 rpm. The reaction was continued at 60° C. for 16 hours, however the CO₂ source was closed off after the initial feed of 10 bar pressure. Once the reaction was finished, the reactor was cooled to below 10° C. and the pressure released very slowly. NMR and GPC were measured immediately.

The reaction with catalyst 6 gave 84% PO conversion with a selectivity for polymer of 66% and produced a polymer with 65% carbonate linkages (28.3 wt % CO₂) and an Mn of 1800 and a PDI of 1.3. The reaction demonstrates significant CO₂ incorporation under low pressures, even at temperatures above the optimum operating temperature of catalyst 6. It also demonstrates control of CO₂ incorporation by variation of the conditions.

### Example 17

### Copolymerisation of PO and CO₂ in the Presence of a Chain Transfer Agent (Starter) Using a DMC Catalyst, Catalyst 6 and a Co-Catalyst

1,12-Dodecanediol (0.83 g) and 3 mg of the DMC catalyst 5 were taken into a 100 mL reactor and dried at 120° C. under vacuum for 1 hour prior to copolymerisation. The reactor vessel was cooled down to room temperature and a propylene oxide (10 mL, 143 mmol) solution of catalyst 6 (0.041 mmol), PPNCl (0.041 mmol) and EtOAc (5 mL) were injected into the vessel via syringe under a continuous flow of CO₂. The vessel was heated to 55° C. and 10 bar of CO₂ pressure was added with continuous stirring at 600 rpm. The reaction was continued at 55° C. for 16 hours, however the CO₂ source was closed off after the initial feed of 10 bar pressure. Once the reaction was finished, the reactor was cooled to below 10° C. and the pressure released very slowly. NMR and GPC were measured immediately.

The reaction with catalyst 6 gave 96% PO conversion with a selectivity for polymer of 84% and produced a polymer with 76% carbonate linkages (33.8 wt % CO₂) and an Mn of 2300 and a PDI of 1.6. The reaction demonstrates significant CO₂ incorporation under low pressures, even at temperatures above the optimum operating temperature of catalyst 6. It also demonstrates a decreased CO₂ content, increased selectivity, conversion and molecular weight generation with respect to comparative example 14 for catalyst 6 on its own, demonstrating the benefits of the tandem catalysis system.

1. A method for preparing a polycarbonate ether polyol, the method comprising reacting carbon dioxide and an epoxide in the presence of a double metal cyanide (DMC) catalyst, a catalyst of formula (I), and a starter compound, wherein the catalyst of formula (I) has the following structure: 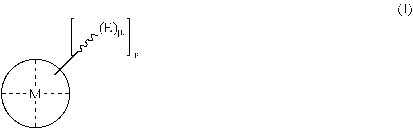
wherein:
M is a metal cation represented by M-(L)ᵥ; 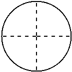
is a multidentate ligand (e.g. it may be either (i) a tetradentate ligand, or (ii) two bidentate ligands);
(E)_{μ} represents one or more activating groups attached to the ligand(s), where [symbol] is a linker group covalently bonded to the ligand, each E is an activating functional group;
and μ is an integer from 1 to 4 representing the number of E groups present on an individual linker group;
L is a coordinating ligand, for example, L may be a neutral ligand, or an anionic ligand that is capable of ring-opening an epoxide;
v is an integer from 0 to 4;
v′ is an integer that satisfies the valency of M, or is such that the complex represented by formula (I) above has an overall neutral charge;
and wherein the starter is a compound having the following structure:
ZR^{Z})ₐ (III)
Z is selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, such as an alkylarylene, heteroalkylarylene, heteroalkylheteroarylene or alkylheteroarylene group;
a is an integer which is at least 2; and
each R^{Z} may be —OH, —NHR′, —SH, —C(O)OH, PR′(O)(OH)₂, —P(O)(OR′)(OH) or —PR′(O)OH; and
wherein if v′ is 0 or if v′ is a positive integer and each L is a neutral ligand which is not capable of ring opening an epoxide, then (i) v is an integer from 1 to 4, or (ii) the step of reacting the carbon dioxide with the epoxide is additionally carried out in the presence of a co-catalyst.

2. The method of claim 1, wherein M is selected from Mg, Ca, Zn, Ti, Cr, Mn, V, Fe, Co, Mo, W, Ru, Al, and Ni.

3. The method of claim 1, wherein 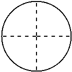
is a tetradentate ligand a salen or salen derivative ligand.

4. The method of claim 1, wherein 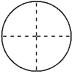
is a tetradentate ligand or a porphyrin or porphyrin derivative ligand.

5. The method of claim 4, wherein M is selected from is selected from Al, Cr and Co.

6. The method of claim 3, wherein the tetradentate ligand is optionally substituted by one or more groups selected from halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups.

7. The method of claim 1, wherein v is 1 or more and E is a nitrogen-containing activating group.

8. The method of claim 1, wherein when L is present and is an anoinic ligand which is capable of ring opening an epoxide, it is independently selected from OC(O)Rₓ, OSO₂Rₓ, OSORₓ, OSO(Rₓ)₂, S(O)Rₓ, ORₓ, phosphinate, halide, nitro, nitrate, hydroxyl, carbonate, amino, amido or optionally substituted aliphatic, heteroaliphatic, alicyclic, heteroalicyclic, aryl or heteroaryl; wherein Rₓ is independently hydrogen, or optionally substituted aliphatic, haloaliphatic, heteroaliphatic, alicyclic, heteroalicyclic, aryl, alkylaryl or heteroaryl.

9. The method of claim 1, wherein when L is present and is a neutral ligand, it is independently selected from water, an alcohol, a substituted or unsubstituted heteroaryl, an ether, a thioether, a carbene, a phosphine, a phosphine oxide, a substituted or unsubstituted heteroalicyclic, an amine, an alkyl amine, acetonitrile, an ester, an acetamide, and a sulfoxide.

10. The method of claim 1, wherein v is 2 and/or μ is 2.

11. The method of claim 1, wherein the catalyst of formula (I) has the following structure: 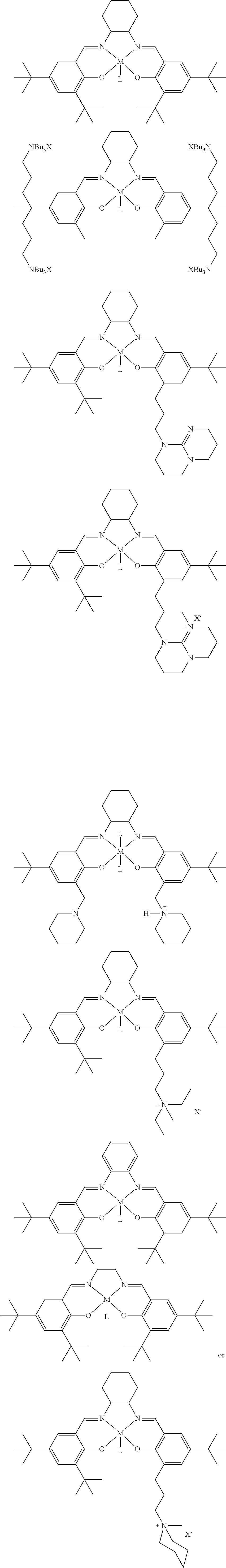
wherein X is an anion, F, Br, I, Cl, BF₄, OAc, O₂COCF₃, NO₃, OR^{a} or O(C═O)R^{a}, wherein R^{a} is selected from H, optionally substituted C₁₋₆ alkyl, optionally substituted C₁₋₆ heteroallkyl, optionally substituted C₆₋₁₂ aryl and optionally substituted C₃₋₁₁ heteroaryl;
L is a coordinating ligand that is capable of ring-opening an epoxide, an anionic ligand which is capable of ring opening an epoxide, OC(O)R^{x} (e.g. OAc, OC(O)CF₃, lactate, 3-hydroxypropanoate), halogen, NO₃, OSO₂R^{x}, (e.g. OSO(CH₃)₂), R^{x} (e.g. Et, Me), OR^{x} (e.g. OMe, OiPr, OtBu, OPh, OBn), Cl, Br, I, F, N(iPr)₂ or N(SiMe₃)₂, salicylate and alkyl or aryl phosphinate (e.g. dioctyl phosphinate);
R^{x} is optionally substituted alkyl, alkenyl, alkynyl, heteroalkyl, aryl, or heteroaryl.

12. The method of claim 1, wherein each occurrence of R^{Z} may be —OH.

13. The method of claim 1, wherein a is an integer in the range of between 2 and 8.

14. The method of claim 1 wherein the reaction is carried out at a pressure of between 1 bar and 20 bar carbon dioxide.

15. The method of claim 1, wherein the reaction is carried out at a temperature in the range of from 5° C. to 200° C.

16. The method of claim 1, wherein the starter compound is from diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4-OH groups, polyols, such as sorbitol or polyalkylene glycols (PEGs or PPGs) having 5 or more —OH groups, diacids such as oxalic acid, malonic acid, succinic acid, glutaric acid, adipic acid, pimelic acid, suberic acid, azelaic acid, sebacic acid, undecanedioic acid, dodecanedioic acid or other compounds having mixed functional groups such as lactic acid, glycolic acid, 3-hydroxypropanoic acid, 4-hydroxybutanoic acid, 5-hydroxypentanoic acid.

17. The method of claim 1, wherein the DMC catalyst comprises at least two metal centres and cyanide ligands.

18. The method of claim 17, wherein the DMC catalyst additionally comprises at least one of: one or more complexing agents, water, a metal salt and/or an acid.

19. The method of claim 1, wherein the DMC catalyst is prepared by treating a solution of a metal salt with a solution of a metal cyanide salt in the presence of at least one of: one or more complexing agents, water, and/or an acid, preferably wherein the metal salt is of the formula M′(X′)p, wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III),
X′ is an anion selected from halide, oxide, hydroxide, sulphate, carbonate, cyanide, oxalate, thiocyanate, isocyanate, isothiocyanate, carboxylate and nitrate,
p is an integer of 1 or more, and the charge on the anion multiplied by p satisfies the valency of M′; the metal cyanide salt is of the formula (Y)_{q}M“(CN)_{b}(A)_{c}, wherein M” is selected from Fe(II), Fe(III), Co(II), Co(III), Cr(II), Cr(III), Mn(II), Mn(III), Ir(III), Ni(II), Rh(III), Ru(II), V(IV), and V(V),
Y is a proton or an alkali metal ion or an alkaline earth metal ion (such as K⁺),
A is an anion selected from halide, oxide, hydroxide, sulphate, cyanide oxalate, thiocyanate, isocyanate, isothiocyanate, carboxylate and nitrate;
q and b are integers of 1 or more;
c may be 0 or an integer of 1 or more;
the sum of the charges on the anions Y, CN and A multiplied by q, b and c respectively (e.g. Y×q+CN×b+A×c) satisfies the valency of M″;
the at least one complexing agent is selected from a (poly)ether, a polyether carbonate, a polycarbonate, a poly(tetramethylene ether diol), a ketone, an ester, an amide, an alcohol, a urea or a combination thereof; and
wherein the acid, if present, has the formula HᵣX′″, where X′″ is an anion selected from halide, sulfate, phosphate, borate, chlorate, carbonate, cyanide, oxalate, thiocyanate, isocyanate, isothiocyanate, carboxylate and nitrate, and r is an integer corresponding to the charge on the counterion X′″.

20. The method of claim 1, wherein the DMC catalyst comprises the formula:
M′_{d}[M″ₑ(CN)_{f}]_{g}
wherein M′ and M″ are as defined in claim 17, and d, e, f and g are integers, and are chosen to such that the DMC catalyst has electroneutrality.

21. The method of claim 19 wherein M′ is selected from Zn(II), Fe(II), Co(II) and Ni(II), preferably wherein M′ is Zn(II).

22. The method of claim 19, wherein M″ is selected from Co(II), Co(III), Fe(II), Fe(III), Cr(III), Ir(III), and Ni(II), preferably wherein M″ is Co(II) or Co(III).

23. The method of claim 1, wherein v is 0.

24. The method of claim 1, wherein the catalyst of formula (I) is used in combination with a co-catalyst, for example, tetraalkyl ammonium salts (e.g. a tetrabutyl ammonium salt), tetraalkyl phosphinium salts (e.g. a tetrabutyl phosphonium salt), bis(triarylphosphine)iminium salts (e.g. a bis(triphenylphosphine)iminium salt), or a nitrogen containing nucleophile (e.g. methylimidazole (such as N-methyl imidazole), dimethylaminopyridine (for example, 4-methylaminopyridine), 1,5,7-Triazabicyclo[4.4.0]dec-5-ene (TBD), 7-Methyl-1,5,7-triazabicyclo[4.4.0]dec-5-ene (MTBD) or 1,8-Diazabicyclo[5.4.0]undec-7-ene (DBU)).

25. The method of claim 1, wherein a polymerisation system for the copolymerisation of carbon dioxide and an epoxide, comprises:
the catalyst of formula (I),
the DMC catalyst, and
the starter compound.

26. The method of claim 1, wherein a polycarbonate ether polyol is prepared.

27. The method of claim 26, wherein a polyurethane or other higher polymer is prepared from a polycarbonate ether polyol.

28. The method of claim 1, wherein a polycarbonate ether polyol is prepared and, wherein the polydispersity index (PDI) is from 1 to less than 2.

29. A polycarbonate ether polyol of formula (IV), 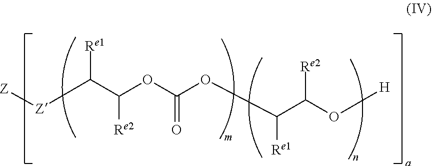
wherein
each R^{e1} and each R^{e2} is independently selected from H, halogen, hydroxyl, or optionally substituted alkyl, alkenyl, alkynyl, cycloalkyl, heterocycloalkyl, aryl, heteroaryl, heteroalkyl or heteroalkenyl;
or wherein R^{e1} and R^{e2} together form a saturated, partially unsaturated or unsaturated ring containing carbon and hydrogen atoms, and optionally one or more heteroatoms (e.g. O, N or S);
Z′ is selected from —O—, —NR′—, —S—, —C(O)O—, —P(O)(OR′)O—, —PR′(O)(O—)₂ or —PR′(O)O— (wherein R′ may be H, or optionally substituted alkyl, heteroalkyl, aryl, heteroaryl, cycloalkyl or heterocycloalkyl, preferably R′ is H or optionally substituted alkyl), preferably Z′ may be —C(O)O—, —NR′— or —O—, more preferably each Z′ may be —O—, —C(O)O— or a combination thereof, more preferably each Z′ may be —O—;
Z is selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, preferably Z is alkylene, heteroalkylene, arylene, or heteroarylene, e.g. alkylene or heteroalkylene;
a is an integer of at least 2; and
wherein m and n define the amount of the carbonate and ether linkages in the polycarbonate ether polyol and n and m are integers of 1 or more, the sum of all m and n groups is from 4 to 200, and wherein m/(m+n) is from 0.05 to 0.95, or from 0.10 to 0.90, or from 0.15 to 0.85, or from 0.20 to 0.80, or from 0.25 to 0.75 or within the ranges 0.50 to 0.95, or 0.70 to 0.95 or 0.70 to 0.90.

30. The polycarbonate ether polyol according to claim 29, wherein the polydispersity index (PDI) is from 1 to less than 2.

31. The polycarbonate ether polyol according to claim 29, wherein the molecular weight is in the range of from 500 to 6,000 Da.

32. The polyurethane ether polyol according to claim 29 wherein a polyurethane or other higher polymer is prepared by a reaction of the polyol according to with a composition comprising a di- or polyisocyanate.
